(19) United States
(12) Patent Application Publication
(10) Pub. No.: US 2023/0222757 A1
(43) Pub. Date: Jul. 13, 2023

(54) SYSTEMS AND METHODS OF MEDIA PROCESSING

(71) Applicant: QUALCOMM Incorporated, San Diego, CA (US)

(72) Inventors: Scott BEITH, Carlsbad, CA (US); Gokce DANE, San Diego, CA (US); Simon Peter William BOOTH, San Diego, CA (US); Rohit BANDI, San Diego, CA (US)

(21) Appl. No.: 17/647,969

(22) Filed: Jan. 13, 2022

(51) Int. Cl. G06V 10/26; G06T 3/40; G06T 5/00; G06V 40/16; G06V 20/62; G06T 7/70; G06V 10/22; G06F 3/16

(52) U.S. Cl. CPC G06V 10/267; G06T 3/40; G06T 5/002; G06T 5/005; G06V 40/161; G06V 20/62; G06T 7/70; G06V 10/235; G06F 3/165; G06T 2207/30201; G06V 2201/02; G06T 2207/20104

(57) ABSTRACT

Media processing systems and techniques are described. A media processing system receives image data that represents an environment captured by an image sensor. The media processing system receives an indication of an object in the environment that is represented in the image data. The media processing system divides the image data into regions, including a first region and a second region. The object is represented in one of the plurality of regions. The media processing system modifies the image data to obscure the first region without obscuring the second region based on the object being represented in the one of the plurality of regions. The media processing system outputs the image data after modifying the image data. In some examples, the object is depicted in the first region and not the second region. In some examples, the object is depicted in the second region and not the first region.

### FIELD

This application is related to media processing. More specifically, this application relates to systems and methods of obscuring and/or attenuating aspects of media corresponding to certain regions of an environment while leaving other aspects of the media unobscured and/or unattenuated, for instance based on object detection and/or semantic segmentation.

### BACKGROUND

Streaming media refers to media (e.g., video and/or audio) that is captured by a capture device and provided over a network (e.g., the Internet) from the capture device to one or more viewer devices in a continuous manner, with little or no intermediate storage in network elements. The streaming media can be provided from the capture device to the one or more viewer devices while the capture device is still capturing media to be provided as a later part of the streaming media, which may be referred to as live-streaming. Because live-streaming has little or no delay between capture and streaming, there is little recourse if unintended parts of a scene are captured.

An extended reality (XR) device is a device that displays an environment to a user, for example through a head-mounted display (HMD) or mobile handset. The environment is at least partially different from the real-world environment in which the user is in. The user can generally change their view of the environment interactively, for example by tilting or moving the HMD or other device. Virtual reality (VR), augmented reality (AR), and mixed reality (MR) are examples of XR. XR devices can include sensors that capture information from the environment. Because an XR device often provides a user with their primary view of their environment during use, the sensors of the XR device can occasionally capture unintended parts of a scene.

### BRIEF SUMMARY

In some examples, systems and techniques are described for media processing. A media processing system receives image data captured by an image sensor. The image data represents (e.g., depicts) an environment. The media processing system receives an indication of an object in the environment that is depicted in the image data, for instance by detecting the object using object detection. The media processing system divides the image data into regions based on the indication of the object, for instance based on a position of the object in the image data. The regions include a first region and a second region. The object is represented in one of the plurality of regions. The media processing system modifies the image data to obscure the first region without obscuring the second region based on the object being represented in the one of the plurality of regions. The media processing system outputs the image data after modifying the image data. In some examples, the object is represented in the first region and not the second region, and the media processing system obscures the first region because the object is in it. In some examples, the object is represented in the second region and not the first region, and the media processing system obscures the first region because the object is not in it. In some examples, the object is a person. The media processing system can obscure regions to improve privacy, for example to obscure faces of people who were not intended to appear in the media. The media processing system can obscure regions in ways that improve bandwidth usage and/or power consumption, for example by obscuring using increased compression in the modified regions, reduced resolution in the modified regions, and the like.

In one example, an apparatus for media processing is provided. The apparatus includes a memory and one or more processors (e.g., implemented in circuitry) coupled to the memory. The one or more processors are configured to and can: receive image data captured by an image sensor, the image data representing an environment; receive an indication of an object in the environment that is represented in the image data; divide the image data into a plurality of regions, wherein the plurality of regions includes a first region and a second region, wherein the object is represented in one of the plurality of regions; modify the image data to obscure the first region without obscuring the second region based on the object being represented in the one of the plurality of regions; and output the image data after modifying the image data.

In another example, a method of image processing is provided. The method includes: receiving image data captured by an image sensor, the image data representing an environment; receiving an indication of an object in the environment that is represented in the image data;

dividing the image data into a plurality of regions, wherein the plurality of regions includes a first region and a second region, wherein the object is represented in one of the plurality of regions; modifying the image data to obscure the first region without obscuring the second region based on the object being represented in the one of the plurality of regions; and outputting the image data after modifying the image data.

In another example, a non-transitory computer-readable medium is provided that has stored thereon instructions that, when executed by one or more processors, cause the one or more processors to: receive image data captured by an image sensor, the image data representing an environment; receive an indication of an object in the environment that is represented in the image data; divide the image data into a plurality of regions, wherein the plurality of regions includes a first region and a second region, wherein the object is de represented in one of the plurality of regions; modify the image data to obscure the first region without obscuring the second region based on the object being represented in the one of the plurality of regions; and output the image data after modifying the image data.

In another example, an apparatus for image processing is provided. The apparatus includes: means for receiving image data captured by an image sensor, the image data representing an environment; means for receiving an indication of an object in the environment that is represented in the image data; means for dividing the image data into a plurality of regions, wherein the plurality of regions includes a first region and a second region, wherein the object is represented in one of the plurality of regions; means for modifying the image data to obscure the first region without obscuring the second region based on the object being represented in the one of the plurality of regions; and means for outputting the image data after modifying the image data.

In some aspects, dividing the image data into the plurality of regions includes dividing the image data into the plurality of regions based on a determined location of the object, wherein the object is located in at least one region and is not located in at least one other region. In some aspects, a location of the object is determined from the image data. In some aspects, one or more of the methods, apparatuses, and computer-readable medium described above further comprise:

detecting audio, wherein a location of the object is determined based on an attribute of the audio, wherein the attribute includes at least one of a location of the audio, a direction of the audio, an amplitude of the audio, or a frequency of the audio.

In some aspects, receiving the indication of the object in the environment includes detecting the object in the image data. In some aspects, receiving the indication of the object in the environment includes an input through a user interface, the input indicative of the object.

In some aspects, the object is represented in the first region and is not represented in the second region, wherein modifying the image data to obscure the first region is based on the object being represented in the first region. In some aspects, the object is represented in the second region and is not represented in the first region, wherein modifying the image data to obscure the first region without obscuring the second region is based on the object being represented in the second region and being not represented in the first region.

In some aspects, modifying the image data to obscure the first region includes modifying the image data using foveated compression of a peripheral area around a fixation point, wherein the second region includes the fixation point, wherein the first region includes the peripheral area.

In some aspects, modifying the image data to obscure the first region includes modifying the image data to blur at least a portion of the first region. In some aspects, modifying the image data to obscure the first region includes modifying the image data to remove at least a portion of the first region. In some aspects, modifying the image data to obscure the first region includes modifying the image data to inpaint at least a portion of the first region. In some aspects, modifying the image data to obscure the first region includes modifying the image data to pixelize at least a portion of the first region.

In some aspects, modifying the image data to obscure the first region includes modifying the image data to reduce a resolution of a first subset of the image data that represents the first region compared to a second subset of the image data that represents the second region.

In some aspects, modifying the image data to obscure the first region includes modifying the image data to compress a first subset of the image data that represents the first region more than a second subset of the image data that represents the second region.

In some aspects, the object includes at least a portion of a body of a person. In some aspects, the object includes at least a portion of a face of a person. In some aspects, the object includes at least a portion of a string of characters. In some aspects, the object includes at least a portion of content displayed using a display.

In some aspects, outputting the image data includes displaying the image data using a display. In some aspects, outputting the image data includes sending the image data to a recipient device using a communication transceiver.

In some aspects, one or more of the methods, apparatuses, and computer-readable medium described above further comprise: receiving audio data captured by a microphone from the environment, the audio data captured at a time corresponding to capture of the image data; detecting, within the audio data, an audio sample corresponding to the object; modifying the audio data to attenuate the audio sample corresponding to the object; and outputting the audio data after modifying the audio data.

In some aspects, at least one region is a region having a predetermined shape.

In some aspects, one or more of the methods, apparatuses, and computer-readable medium described above further comprise: receiving secondary image data from a second image sensor, the second image sensor having a different field of view to the first image sensor, the secondary image data captured by the second image sensor including a secondary image of a user, wherein the dividing of the image data is further based on the secondary image. In some aspects, the second image sensor captures a gesture or position of at least a portion of the user, and wherein the dividing of the image data includes defining a region corresponding to a direction of the gesture and/or position of at least the portion of the user. In some aspects, the gesture or position of the user comprises a gaze direction of the user.

In some aspects, modifying the image data to obscure the first region reduces an amount of data used to code the first region. In some aspects, modify the image data to obscure the first region comprises at least one of increasing compression in the first region, increasing quantization in the first region, reducing resolution in the first region, cropping the first region, and/or pixelating the first region.

In some aspects, one or more of the methods, apparatuses, and computer-readable medium described above further comprise: identifying the object; and determining whether the object is to be displayed or obscured based on identifying the object; and defining the first region to include the object in response to determining that the object is to be obscured. In some aspects, determining that the object is to be obscured comprises determining that the object is included in a black list of objects to be obscured and/or determining that the object is not included in a white list of objects to be displayed.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a block diagram illustrating an example architecture of an image capture and processing system, in accordance with some examples;

FIG. 2 is a block diagram illustrating an example architecture of a media processing system performing a process receiving media captured by sensors and modifying the media, in accordance with some examples;

FIG. 3A is a perspective diagram illustrating a head-mounted display (HMD) that is used as an extended reality (XR) system, in accordance with some examples;

FIG. 3B is a perspective diagram illustrating the head-mounted display (HMD) of FIG.

3A being worn by a user, in accordance with some examples;

FIG. 4A is a perspective diagram illustrating a front surface of a mobile handset that includes front-facing cameras and that can be used as an extended reality (XR) system, in accordance with some examples;

FIG. 4B is a perspective diagram illustrating a rear surface of a mobile handset that includes rear-facing cameras and that can be used as an extended reality (XR) system, in accordance with some examples;

FIG. 5 is a block diagram illustrating a process 500 for image processing based on an event, in accordance with some examples;

FIG. 6 is a block diagram illustrating a process 600 for image processing based on detection of a person in image data, in accordance with some examples;

FIG. 7A is a conceptual diagram illustrating examples of an image of an environment and various modifications to the image to obscure portions of the environment indicated using dashed lines, in accordance with some examples;

FIG. 7B is a conceptual diagram illustrating examples of an image of an environment and various modifications to the image to obscure portions of the environment indicated using shading, in accordance with some examples;

FIG. 8 is a conceptual diagram illustrating examples of a soundscape of an environment and various modifications to attenuate aspects of the soundscape corresponding to different elements in the environment, in accordance with some examples;

FIG. 9 is a block diagram illustrating an example of a neural network that can be used for media processing operations, in accordance with some examples;

FIG. 10 is a flow diagram illustrating a process for media processing, in accordance with some examples; and

FIG. 11 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Extended reality (XR) systems or devices can provide virtual content to a user and/or can combine real-world views of physical environments (scenes) and virtual environments (including virtual content). XR systems facilitate user interactions with such combined XR environments. The real-world view can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

Systems and techniques are described herein for media processing. A media processing system receives image data captured by an image sensor. The image data represents (e.g., depicts) an environment. The media processing system receives an indication of an object in the environment that is represented (e.g., depicted) in the image data, for instance by detecting the object. The media processing system divides the image data into regions, for instance based on the indication of the object, the detection of the object, the position of the object in the environment, and/or the position of the object in the image data. The regions include a first region and a second region. The object is represented (e.g., depicted) in one of the plurality of regions. The media processing system modifies the image data to obscure the first region without obscuring the second region based on the object being represented in the one of the plurality of regions. The media processing system outputs the image data after modifying the image data. In some examples, the object is represented (e.g., depicted) in the first region and not the second region, and the media processing system obscures the first region because the object is in it. In some examples, the object is represented (e.g., depicted) in the second region and not the first region, and the media processing system obscures the first region because the object is not in it. In some examples, the object is a person, a face, a vehicle, a plant, an animal, a structure, a device, content displayed on a device, content written or drawn on a medium, or a combination thereof.

The media processing systems and techniques described herein provide a number of technical improvements over prior media systems. For instance, the media processing systems and techniques described herein can obscure regions in ways that improve bandwidth usage and/or power consumption, for example by obscuring using increased compression in the modified regions, reduced resolution in the modified regions, and the like. In some examples, the media processing systems and techniques described herein can improve privacy and security, for example to by obscuring faces of people or objects that were not intended to appear in the media.

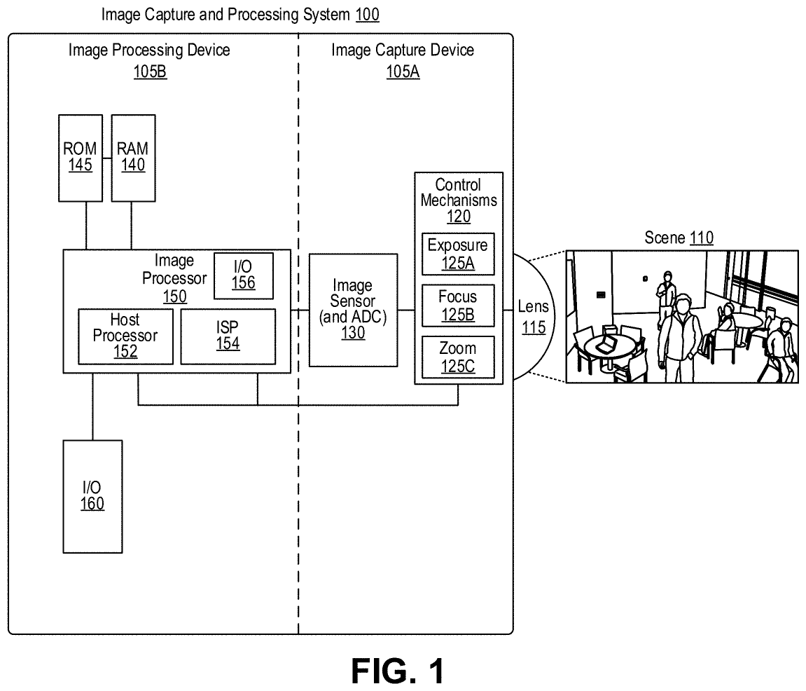

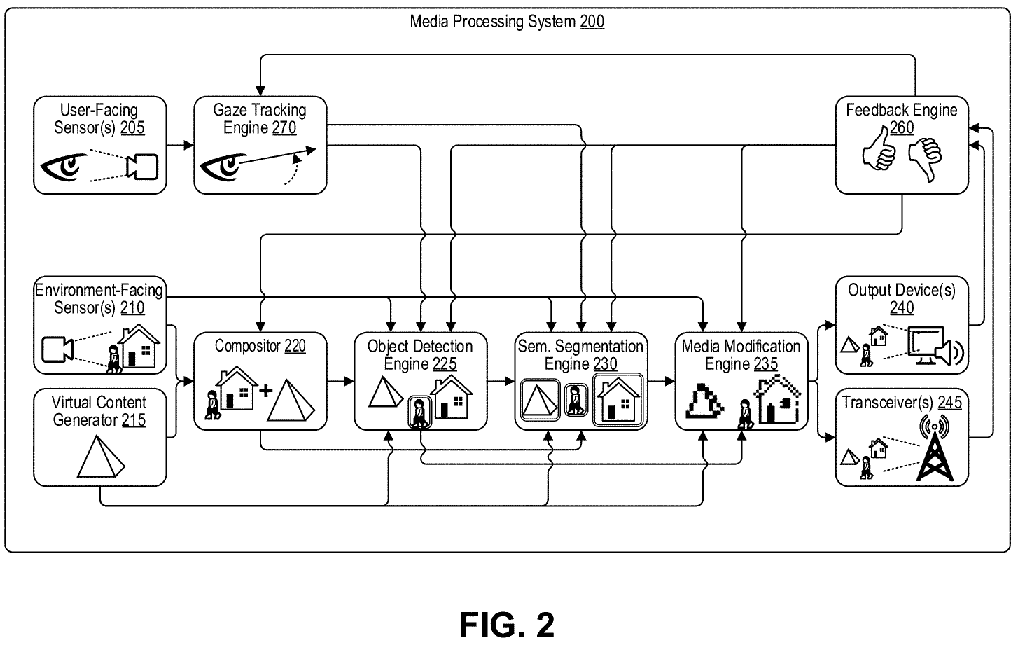

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment, such as the environment that the environment-facing sensors 210 of FIG. 2 are facing. In some examples, the scene 110 is a scene of at least a portion of a user, such as the user that the user-facing sensors 205 of FIG. 2 are facing. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof

The image processor 150 may include one or more processors, such as one or more image signal processors (ISPs) (including ISP 154), one or more host processors (including host processor 152), and/or one or more of any other type of processor 1110 discussed with respect to the computing system 1100. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., BluetoothTM, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1120, read-only memory (ROM) 145 and/or 1125, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fe communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

FIG. 2 is a block diagram illustrating an example architecture of a media processing system 200 performing a process receiving media captured by sensors and modifying the media.

In some examples, the media processing system 200 includes at least one image capture and processing system 100, image capture device 105A, image processing device 105B, or combination(s) thereof. In some examples, the media processing system 200 includes at least one computing system 1100. In some examples, the media processing system 200 includes at least one neural network 900.

In some examples, the media processing system 200 includes one or more user-facing sensors 205. The user-facing sensors 205 capture sensor data measuring and/or tracking information about aspects of the user's body and/or behaviors by the user. In some examples, the user-facing sensors 205 include one or more cameras that face at least a portion of the user. The one or more cameras can include one or more image sensors that capture images of at least a portion of the user. For instance, the user-facing sensors 205 can include one or more cameras focused on one or both eyes (and/or eyelids) of the user, with the image sensors of the cameras capturing images of one or both eyes of the user. The one or more cameras may also be referred to as eye capturing sensor(s). In some implementations, the one or more cameras can capture series of images over time, which in some examples may be sequenced together in temporal order, for instance into videos. These series of images can depict or otherwise indicate, for instance, movements of the user's eye(s), pupil dilations, blinking (using the eyelids), squinting (using the eyelids), saccades, fixations, eye moisture levels, optokinetic reflexes or responses, vestibulo-ocular reflexes or responses, accommodation reflexes or responses, other attributes related to eyes and/or eyelids described herein, or a combination thereof. Within FIG. 2, the one or more user-facing sensors 205 are illustrated as a camera facing an eye of the user and capturing images of the eye of the user.

The user-facing sensors 205 can include one or more sensors that track information about the user's body and/or behaviors, such as one or more cameras, image sensors, microphones, heart rate monitors, oximeters, biometric sensors, positioning receivers, Global Navigation Satellite System (GNSS) receivers, Inertial Measurement Units (IMUs), accelerometers, gyroscopes, gyrometers, barometers, thermometers, altimeters, depth sensors, light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, other sensors discussed herein, or combinations thereof. In some examples, the one or more user-facing sensors 205 include at least one image capture and processing system 100, image capture device 105A, image processing device 105B, or combination(s) thereof. In some examples, the one or more user-facing sensors 205 include at least one input device 1145 of the computing system 1100. In some implementations, one or more of the user-facing sensor(s) 205 may complement or refine sensor readings from other user-facing sensor(s) 205 and/or the environment-facing sensor(s) 210. For example, Inertial Measurement Units (IMUs), accelerometers, gyroscopes, or other sensors may be used by the gaze tracking engine 270 to refine the determination of the user's gaze.

The one or more environment-facing sensors 210 of the media processing system 200 are one or more sensors that are pointed, directed, and/or focused toward an environment. In some examples, the one or more environment-facing sensors 210 face away from the user. The user-facing sensor(s) 205 face a first direction, while the environment-facing sensor(s) 210 face a second direction. In some examples, the second direction is parallel to the first direction. In some examples, the first direction and the second direction are opposing directions, opposite directions, and/or reverse directions, relative to one another. In some examples, the one or more environment-facing sensors 210 can be pointed, directed, and/or face in a direction that the face of the user is facing. In some examples, the one or more environment-facing sensors 210 can be pointed, directed, and/or face in a direction that the media processing system 200 (or a side thereof) is facing.

The environment-facing sensors 210 capture sensor data measuring and/or tracking information about the real-world environment in front of and/or around the media processing system 200 and/or the user. In some examples, the environment-facing sensors 210 include one or more cameras that face at least a portion of the real-world environment. The one or more cameras can include one or more image sensors that capture images of at least a portion of the real-world environment. For instance, the environment-facing sensors 210 can include one or more cameras focused on the real-world environment (e.g., on a surrounding of the media processing system 200), with the image sensors of the cameras capturing images of the real-world environment (e.g., of the surrounding). Such cameras can capture series of images over time, which in some examples may be sequenced together in temporal order, for instance into videos. These series of images can depict or otherwise indicate, for instance, floors, ground, walls, ceilings, sky, water, plants, other people other than the user, portions of the user's body (e.g., arms or legs), structures, vehicles, animals, devices, other objects, or combinations thereof. Within FIG. 2, the one or more environment-facing sensors 210 are illustrated as a camera facing a house (e.g., a structure) and a person. In some examples, the one or more environment-facing sensors 210 include at least one image capture and processing system 100, image capture device 105A, image processing device 105B, or combination(s) thereof. In some examples, the one or more environment-facing sensors 210 include at least one input device 1145 of the computing system 1100. The environment-facing sensors 210 can include cameras, image sensors, positioning receivers, GNSS receivers, IMUs, accelerometers, gyroscopes, gyrometers, barometers, thermometers, altimeters, depth sensors, LIDAR sensors, RADAR sensors, SODAR sensors, SONAR sensors, ToF sensors, structured light sensors, other sensors discussed herein, or combinations thereof.

In some implementations, one or more of the environment-facing sensor(s) 210 may complement or refine sensor readings from other user-facing sensor(s) 205 and/or the environment-facing sensor(s) 210. For example, sensor data from cameras, image sensors, depth sensors, LIDAR sensors, RADAR sensors, SODAR sensors, SONAR sensors, ToF sensors, and/or structured light sensors may be combined or otherwise used together by the object detection engine 225 to detect an object within the environment, and/or by the semantic segmentation engine 230 to segment representations of the environment.

In some examples, a user input can further be used to detect an object within the environment. In an illustrative example, a touchscreen user interface can receive a user touch input at a position on the touchscreen on which a preview image of the environment is displayed, and the position of the touch input can be used by the object detection engine 225 to identify a corresponding position in the preview image—and/or other image data—and/or other sensor data—as having an object, or being likely to have an object (e.g., having a reduced confidence threshold for object recognition). In another illustrative example, a mouse user interface can receive a click input at a position on the screen on which a preview image of the environment is displayed, and the position of the click input can be used by the object detection engine 225 to identify a corresponding position in the preview image—and/or other image data—and/or other sensor data—as having an object, or being likely to have an object (e.g., having a reduced confidence threshold for object recognition).

In some examples, the one or more of the environment-facing sensor(s) 210 may include one or more microphones that may record audio from the environment. In some examples, the one or more of the environment-facing sensor(s) 210 may include multiple microphones, so that direction and/or position of the audio in the environment can be determined from differences in the audio recorded at the different microphones. In some examples, audio can further be used to detect an obj ect within the environment. For instance, if the microphone(s) of the environment-facing sensor(s) 210 detect a voice, the object detection engine 225 can increase the likelihood of detecting a person in the environment and/or in the image data. In some examples, attributes of the audio, such as direction that the audio is coming from, direction that the audio signal is traveling, location of the audio (e.g., determined via triangulation), amplitude of the audio, and/or frequency of the audio can suggest the position of the object to the object detection engine 225, which can increase the likelihood of detecting a person in that portion of the environment and/or in the image data depicting that portion of the environment (e.g., having a reduced confidence threshold for object recognition). For instance, direction of the audio and/or location of the audio can identify a direction that the object is relative to the microphone(s) (and/or the environment-facing sensor(s) 210 or other portions of the media processing system 200). Location of the audio, amplitude of the audio, and/or frequency of the audio can indicate how far the object is relative to the microphone(s) (and/or the environment-facing sensor(s) 210 or other portions of the media processing system 200). Frequency of the audio can indicate whether the object moving relative to the microphone(s) (and/or the environment-facing sensor(s) 210 or other portions of the media processing system 200), for instance based on the Doppler effect. Such indications, based on the audio, can be used by the object detection engine 225 to identify a corresponding position in the image data—and/or other sensor data—as having an object, or being likely to have an object (e.g., having a reduced confidence threshold for object recognition), for instance based on direction (e.g., where in the image to look for the object), distance (e.g., whether to look for the object in the foreground or background), speed (e.g., whether the object may include motion blur), or a combination thereof.

In some examples, the media processing system 200 includes a virtual content generator 215 that generates virtual content. The virtual content can include two-dimensional (2D) shapes, three-dimensional (3D) shapes, 2D objects, 3D objects, 2D models, 3D models, 2D animations, 3D animations, 2D images, 3D images, textures, portions of other images, characters, strings of characters, or combinations thereof. Within FIG. 2, the virtual content generated by the virtual content generator 215 is illustrated as a tetrahedron. In some examples, the virtual content generator 215 includes one or more software elements, such as one or more sets of instructions corresponding to one or more programs, that are run on one or more processors of the media processing system 200, such as the processor 1110 of the computing system 1100, the image processor 150, the host processor 152, the ISP 154, or a combination thereof. In some examples, the virtual content generator 215 includes one or more hardware elements. For instance, the virtual content generator 215 can include a processor such as the processor 1110 of the computing system 1100, the image processor 150, the host processor 152, the ISP 154, or a combination thereof. In some examples, the virtual content generator 215 includes a combination of one or more software elements and one or more hardware elements.

In some examples, the media processing system 200 includes one or more output devices 240 that are configured to, and can, output media. In some examples, the output device(s) 240 include display(s) that are configured to, and can, display visual media, such as images and/or videos. In some examples, the output device(s) 240 include audio output device(s), such as loudspeakers or headphones or connectors that are configured to couple the media processing system 200 to loudspeakers or headphones. The audio output device(s) are configured to, and can, play audio media, such as music, sound effects, audio tracks corresponding to videos, audio recording recorded by microphone(s) (e.g., of the user-facing sensor(s) 205, of the environment-facing sensor(s) 210, and/or of additional sensor(s) of the media processing system 200), or combinations thereof. The output device(s) 240 may output media that includes a representation of the environment (e.g., as captured by the environment-facing sensor(s) 210), virtual content (e.g., as generated by the virtual content generator 215), a combination of the representation of the environment and the virtual content (e.g., as generated by the compositor 220), modification(s) to the representation(s) of the environment and/or to the virtual content and/or the combination (e.g., as generated by the media modification engine 235), or a combination thereof. In some examples, the output device(s) 240 can face the user of the media processing system 200. For instance, the display(s) of the output device(s) 240 can face the user of the media processing system 200, and/or can display visual media to (e.g., toward) the user of the media processing system 200. Similarly, the audio output device(s) of the output device(s) 240 can face the user of the media processing system 200, and/or can play audio media to (e.g., toward) the user of the media processing system 200. In some examples, the output device(s) 240 include an output device 1135. In some examples, the output device 1135 can include the output device(s) 240.

The media processing system 200 includes a compositor 220. The compositor 220 composes, composites, and/or combines the virtual content (e.g., generated by the virtual content generator 215) with representation(s) of the environment. In some examples, the representation(s) of the environment are captured by the environment-facing sensor(s) 210. In some examples, the representation(s) of the environment are visible to the user based on light from the environment reaching the user through a portion of the media processing system 200 (e.g., through at least a portion of the display(s) of the output device(s) 240).

In some examples, the display(s) of the output device(s) 240 of the media processing system 200 function as optical “see-through” display(s) that allow light from the real-world environment (scene) around the media processing system 200 to traverse (e.g., pass) through the display(s) of the output device(s) 240 to reach one or both eyes of the user. For example, the display(s) of the output device(s) 240 can be at least partially transparent, translucent, light-permissive, light-transmissive, or a combination thereof. In an illustrative example, the display(s) of the output device(s) 240 includes a transparent, translucent, and/or light-transmissive lens and a projector. The display(s) of the output device(s) 240 of can include a projector that projects the virtual content onto the lens. The lens may be, for example, a lens of a pair of glasses, a lens of a goggle, a contact lens, a lens of a head-mounted display (HMD) device, or a combination thereof. Light from the real-world environment passes through the lens and reaches one or both eyes of the user. Because the projector projects the virtual content onto the lens, the virtual content appears to be overlaid over the user's view of the environment from the perspective of one or both of the user's eyes. The compositor 220 can determine and/or modify display settings that control positioning of the virtual content as projected onto the lens by the display(s) of the output device(s) 240.

In some examples, the display(s) of the output device(s) 240 of the media processing system 200 include projector(s) without the lens discussed above with respect to the optical see-through display. In such examples, the output device(s) 240 can use the projector(s) to project the virtual content onto one or both eyes of the user. In some examples, the projector of the display(s) of the output device(s) 240 can project the virtual content onto one or both retinas of one or both eyes of the user. In such examples, the display(s) of the output device(s) 240 can be referred to as an optical see-through display, a virtual retinal display (VRD), a retinal scan display (RSD), or a retinal projector (RP) display. Light from the real-world environment (scene) still reaches one or both eyes of the user in such examples. Because the projector projects the virtual content onto one or both eyes of the user, the virtual content appears to be overlaid over the user's view of the environment from the perspective of one or both of the user's eyes. The compositor 220 can determine and/or modify display settings that control positioning of the virtual content as projected onto the user's eye(s) by the display(s) of the output device(s) 240.

In some examples, the display(s) of the output device(s) 240 of the media processing system 200 are digital “pass-through” display that allow the user of the media processing system 200 to see a view of an environment by displaying the view of the environment on the display(s) of the output device(s) 240. The view of the environment that is displayed on the digital pass-through display can be a view of the real-world environment around the media processing system 200, for example based on sensor data (e.g., images, videos, depth images, point clouds, other depth data, or combinations thereof) captured by one or more environment-facing sensors 210 of the media processing system 200. In some examples, the view of the environment that is displayed on the digital pass-through display can include virtual content (e.g., generated by the virtual content generator 215) and/or modifications (e.g., by the media modification engine 235) incorporated into the view of the environment.

The view of the environment that is displayed on the pass-through display can be a view of a virtual environment or a mixed environment that is distinct from the real-world environment but that is based on the real-world environment. For instance, the virtual environment or a mixed environment can include virtual objects and/or backgrounds, but that may be mapped to areas and/or volumes of space with dimensions that are based on dimensions of areas and/or volumes of space within the real-world environment that the user and the media processing system 200 are in. The media processing system 200 can determine the dimensions of areas and/or volumes of space within the real-world environment that the user and the media processing system 200 are in. In some implementations, the environment-facing sensor(s) 210 of the media processing system 200 can include cameras and/or image sensors that capture images of the environment (e.g., surroundings of the media processing system 200) and/or depth sensors (e.g., LIDAR, RADAR, SONAR, SODAR, ToF, structured light) that capture depth data (e.g., point clouds, depth images) of the environment. This can ensure that, while the user explores the virtual environment or mixed environment displayed on the display(s) of the output device(s) 240, the user does not accidentally fall down a set of stairs, run into a wall or obstacle, or otherwise have a negative interaction and/or potentially dangerous interaction with the real-world environment.

The media processing system 200, in examples where the display(s) of the output device(s) 240 are digital pass-through displays, can use the compositor 220 to overlay the virtual content generated by the virtual content generator 215 over at least a portion of the environment as captured using the environment-facing sensor(s) 210. In some examples, the compositor 220 can overlay the virtual content fully over the environment displayed on the display(s) of the output device(s) 240, so that the virtual content appears, from the perspective of one or both eyes of the user viewing the display(s) of the output device(s) 240, to be fully in front of the rest of the environment that is displayed on the display(s) of the output device(s) 240. In some examples, the compositor 220 can overlay at least a portion of the virtual content over portions of the environment displayed on the display(s) of the output device(s) 240, so that the virtual content appears, from the perspective of one or both eyes of the user viewing the display(s) of the output device(s) 240, to be in front some portions of the environment that is displayed on the display(s) of the output device(s) 240, but behind other portions of the environment that is displayed on the display(s) of the output device(s) 240. The compositor 220 can thus provide a simulated depth to the virtual content, overlaying portions of the environment that are displayed on the display(s) of the output device(s) 240 over portions of the virtual content.

The media processing system 200, in an example where the display(s) of the output device(s) 240 are optical see-through displays, can use the compositor 220 to spare a portion of the real-world environment from becoming overlaid by the virtual content generated by the virtual content generator 215. In some examples, the compositor 220 can overlay the virtual content only partially over the real-world environment on the display, so that the virtual content appears, from the perspective of one or both eyes of the user viewing the display(s) of the output device(s) 240, to be behind at least a portion of the real-world environment. In some examples, the compositor 220 can overlay the virtual content only partially over the real-world environment on the display, so that the virtual content appears, from the perspective of one or both eyes of the user viewing the display(s) of the output device(s) 240, to be behind at least a portion of the real-world environment and in front of other portions of the real-world environment. The compositor 220 can thus provide a simulated depth to the virtual content, sparing portions of the real-world environment from being overlaid by virtual content. The positioning of the virtual content relative to the environment can be identified and/or indicated by display settings (e.g., first display settings, second display settings). The compositor 220 can determine and/or modify the display settings.

Regardless of whether the display(s) of the output device(s) 240 are optical see-through displays or digital pass-through displays, the display(s) of the output device(s) 240 can in some cases provide a 3D view of the environment, the virtual content, and/or the modifications to the user. For instance, the media processing system 200 can output, to the display(s) of the output device(s) 240, two slightly different perspectives to each of the two eyes of the user to provide a stereoscopic view of the environment, in some cases with the virtual content and/or modifications incorporated, so that the display(s) of the output device(s) 240 provide a 3D view to the user.

The compositor 220 of the media processing system 200 can determine display settings for the display(s) of the output device(s) 240 (e.g., first display settings). In an media processing system 200 in which the display(s) of the output device(s) 240 is a digital “pass-through” display, the compositor 220 can generate an image that composes, composites, and/or combines a view of the environment (e.g., based on sensor data from the environment-facing sensors 210) with the virtual content generated by the virtual content generator 215. The display settings generated by the compositor 220 can indicate the position, orientation, depth, size, color, font size, font color, text language, layout, and/or other properties of the virtual content, and/or of specific elements or portions of the virtual content. In an media processing system 200 in which the display(s) of the output device(s) 240 is an optical “see-through” display, the compositor 220 can generate display settings indicating a position, orientation, depth, size, color, font size, font color, text language, and/or other properties of the virtual content, and/or of specific elements or portions of the virtual content, as displayed by the display(s) of the output device(s) 240 (e.g., as projected onto the lens(s) and/or eye(s) by the projector(s) of the display(s) of the output device(s) 240). Within FIG. 2, the compositor 220 is illustrated as adding the virtual content (represented by the tetrahedron) to the view of the environment (represented by the house and the person). Within FIG. 2, the output device(s) 240 are illustrated as a display displaying and/or providing a view of both the virtual content (represented by the tetrahedron) and the view of the environment (represented by the house and the person), as well as a speaker outputting audio corresponding to one or both of these.

In some examples, the compositor 220 includes ML system(s) and/or trained ML model(s) that receive, as inputs, the sensor data from the environment-facing sensor(s) 210, the virtual content generated by the virtual content generator 215, and/or gaze data from the gaze tracking engine 270. The ML system(s) and/or trained ML model(s) output combined media that includes at least a portion of the sensor data from the environment-facing sensor(s) 210 and at least a portion of the virtual content. In some cases, the ML system(s) and/or trained ML model(s) can position the virtual content based on the gaze data. In some examples, the ML system(s) and/or trained ML model(s) of the compositor 220 may include one or more neural network (NNs) (e.g., neural network 900), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more other types of neural networks, one or more trained support vector machines (SVMs), one or more trained random forests (RFs), one or more computer vision systems, one or more deep learning systems, or combinations thereof.

In some examples, the compositor 220 includes a software element, such as a set of instructions corresponding to a program, that is run on a processor such as the processor 1110 of the computing system 1100, the image processor 150, the host processor 152, the ISP 154, or a combination thereof. In some examples, the compositor 220 includes one or more hardware elements. For instance, the compositor 220 can include a processor such as the processor 1110 of the computing system 1100, the image processor 150, the host processor 152, the ISP 154, or a combination thereof. In some examples, the compositor 220 includes a combination of one or more software elements and one or more hardware elements.

The media processing system 200 includes an object detection engine 225. In some examples, object detection engine 225 receives visual media data (e.g., images, videos) from the environment-facing sensor(s) 210, the virtual content generator 215, and/or the compositor 220. The object detection engine 225 detects, recognizes, classifies, and/or tracks one or more feature(s), object(s), face(s), person(s), animal(s), device(s), and/or vehicle(s). The object detection engine 225 can include one or more machine learning (ML) systems with one or more trained ML models. The object detection engine 225 can perform feature detection, feature extraction, feature recognition, feature tracking, object detection, object recognition, object tracking, facial detection, facial recognition, facial tracking, person detection, person recognition, person tracking, animal detection, animal recognition, animal tracking, device detection, device recognition, device tracking, vehicle detection, vehicle recognition, vehicle tracking, classification, or a combination thereof. The object detection engine 225 can perform these operations by inputting the visual media data into the trained ML model(s), and receiving as outputs of the trained ML model(s) the detection of the feature(s), object(s), face(s), person(s), animal(s), device(s), and/or vehicle(s). This detection can identify a location and/or region, in the visual media data, at which the feature(s), object(s), face(s), person(s), animal(s), device(s), and/or vehicle(s) are located.

The ML system(s) and/or trained ML model(s) of the object detection engine 225 may include one or more NNs, one or more CNNs, one or more TDNNs, one or more deep networks, one or more autoencoders, one or more DBNs, one or more RNNs, one or more GANs, one or more trained SVMs, one or more trained RFs, one or more computer vision systems, one or more deep learning systems, or combinations thereof. In some examples, the object detection engine 225 generates a confidence level associated with each detection of feature(s), obj ect(s), face(s), person(s), animal(s), device(s), and/or vehicle(s) in the visual media data, and reports the detection (e.g., to the semantic segmentation engine 230 and/or the media modification engine 235) if the confidence level meets or exceeds a predetermined confidence level threshold.

In some examples, object detection engine 225 receives audio media data (e.g., sound clips, music clips, audio samples, and/or audio recordings) from microphone(s) of the environment-facing sensor(s) 210, the virtual content generator 215, and/or the compositor 220. The object detection engine 225 detects, recognizes, classifies, and/or tracks one or more sound clips, music clips, audio samples, and/or audio recordings within the audio media data. In some examples, the object detection engine 225 detects, recognizes, classifies, and/or tracks audio corresponding to a particular object (e.g., person, vehicle, device, animal, or other object). The object detection engine 225 can include one or more machine learning (ML) systems with one or more trained ML models. The obj ect detection engine 225 can perform audio feature detection, audio feature extraction, audio feature recognition, audio feature tracking, voice detection, voice recognition, voice tracking, device sound detection, device sound recognition, device sound tracking, animal sound detection, animal sound recognition, animal sound tracking, animal detection, vehicle sound recognition, vehicle sound tracking, vehicle sound detection, vehicle sound recognition, vehicle sound tracking, object sound detection, object sound recognition, object sound tracking, classification, or a combination thereof. The object detection engine 225 can perform these operations by inputting the audio media data into the trained ML model(s), and receiving as outputs of the trained ML model(s) the detection of the sounds corresponding to audio feature(s), object(s), voice(s), animal(s), device(s), and/or vehicle(s). This detection can identify the audio characteristics of the sound (e.g., frequencies and/or amplitudes and/or sound directions) and/or time(s), in the audio media data, at which the sounds corresponding to the audio feature(s), object(s), voice(s), animal(s), device(s), and/or vehicle(s) occur. Within FIG. 2, the object detection engine 225 are illustrated as a bounding box around the person in the media, but not around the house or the tetrahedron.

The ML system(s) and/or trained ML model(s) may include one or more NNs, one or more CNNs, one or more TDNNs, one or more deep networks, one or more autoencoders, one or more DBNs, one or more RNNs, one or more GANs, one or more trained SVMs, one or more trained RFs, one or more deep learning systems, or combinations thereof. In some examples, the object detection engine 225 generates a confidence level associated with each detection of sounds corresponding to audio feature(s), object(s), voice(s), animal(s), device(s), and/or vehicle(s) in the audio media data, and reports the detection (e.g., to the semantic segmentation engine 230 and/or the media modification engine 235) if the confidence level meets or exceeds a predetermined confidence level threshold.

In some examples, object detection engine 225 receives gaze data from the gaze tracking engine 270, and uses the gaze data as an input to the ML systems and/or trained ML model(s) of the object detection engine 225. If the gaze data indicates that the user is looking at a particular region of the environment, the object detection engine 225 can reduce a confidence threshold of the object detection engine 225 for that region of the environment, so that the object detection engine 225 indicates detection of object(s) in the region if the confidence meets or exceeds the predetermined reduced confidence threshold, even if it does not meet or exceed a standard confidence threshold.

In some examples, the object detection engine 225 detects, recognizes, and/or tracks portion(s) of the user's body, such as one or more of the user's hands and/or feet. In some examples, hand or foot of the user can be one of the object(s) detected in the media by the object detection engine 225. In some examples, object detection engine 225 detects, recognizes, and/or tracks one or more objects held and/or touched by the hand(s) of the user. In some examples, object detection engine 225 detects, recognizes, and/or tracks one or more objects stood on and/or touched by one or both feet of the user. In some examples, object detection engine 225 detects, recognizes, and/or tracks one or more objects that the user points and/or gestures toward using one or more hands or feet of the user. In some examples, the object detection engine 225 can reduce a confidence threshold of the object detection engine 225 for a region of the environment that one or more hands or feet of the user are holding, touching, pointing toward, gesturing toward, or a combination thereof. Thus, the object detection engine 225 can indicate detection of obj ect(s) in the region if the confidence meets or exceeds the predetermined reduced confidence threshold, even if it does not meet or exceed a standard confidence threshold.

In some examples, the object detection engine 225 includes a software element, such as a set of instructions corresponding to a program, that is run on a processor such as the processor 1110 of the computing system 1100, the image processor 150, the host processor 152, the ISP 154, or a combination thereof. In some examples, the object detection engine 225 includes one or more hardware elements. For instance, the object detection engine 225 can include a processor such as the processor 1110 of the computing system 1100, the image processor 150, the host processor 152, the ISP 154, or a combination thereof. In some examples, the object detection engine 225 includes a combination of one or more software elements and one or more hardware elements.

The media processing system 200 includes a semantic segmentation engine 230. The semantic segmentation engine 230 divides media (e.g., media captured by the environment-facing sensor(s) 210, virtual content generated by the virtual content generator 215, and/or combined media generated by the compositor 220) into segments. In some examples, the semantic segmentation engine 230 can divide the media into the segments, or regions, based on location(s) of one or more feature(s), obj ect(s), face(s), person(s), animal(s), device(s), and/or vehicle(s) detected in the visual media data by the object detection engine 225. For instance, the semantic segmentation engine 230 can divide one or more images into a first region and a second region. The first region includes one or more feature(s), object(s), face(s), person(s), animal(s), device(s), and/or vehicle(s) detected in the visual media data by the object detection engine 225. The second region lacks (does not include and/or is missing) the one or more feature(s), object(s), face(s), person(s), animal(s), device(s), and/or vehicle(s) detected in the visual media data by the object detection engine 225.

In some examples, the semantic segmentation engine 230 can divide the media into the segments, or regions, based on location(s) and/or direction(s) of sound(s) corresponding to audio feature(s), object(s), voice(s), animal(s), device(s), and/or vehicle(s) detected in the audio media data by the object detection engine 225. For instance, the semantic segmentation engine 230 can divide one or more images into a first region and a second region. The first region includes the location(s) and/or direction(s) of sound(s) corresponding to audio feature(s), object(s), voice(s), animal(s), device(s), and/or vehicle(s) detected in the audio media data by the object detection engine 225. The second region lacks (does not include and/or is missing) the location(s) and/or direction(s) of sound(s) corresponding to audio feature(s), object(s), voice(s), animal(s), device(s), and/or vehicle(s) detected in the audio media data by the object detection engine 225. Within FIG. 2, the semantic segmentation engine 230 are illustrated as including separate boxes defining separate regions around the person, the house, and the tetrahedron (the virtual content).

In some examples, the regions are two-dimensional (2D), for instance where the media includes two-dimensional images, videos, or other media. In some examples, the regions have, or include, polygonal shapes, for example being square, rectangular, quadrilateral, triangular, pentagonal, hexagonal, or another polygonal shape. In some examples, the regions have, or include, rounded shapes, for examples being circular, elliptical, or another rounded shape. In some examples, the regions are three-dimensional (3D) for instance where the media includes three-dimensional depth images, point clouds, video depth data, or other media. In some examples, the regions have, or include, polyhedral shapes, for example including cubes, rectangular prisms, quadrilateral prisms, triangular prisms, pentagonal prisms, hexagonal prisms, tetrahedrons, pyramids, or another polyhedral shape. In some examples, the regions have, or include, rounded 3D shapes, for example including spheres, ellipsoids, cylinders, cones, or another rounded shape. In some examples, the boundaries of the regions in the media are, or are based on, the boundaries in the media of the one or more feature(s), object(s), face(s), person(s), animal(s), device(s), and/or vehicle(s) detected in the media by the object detection engine 225. In some examples, the boundaries of the regions in the media are based on fractional or decimal semantic segmentations of the media, for instance the left half and the right half, or the top half and the bottom half, or a diagonal half, or a quadrant, or a horizontal or vertical third, or another similar semantic segmentation. In some examples, the boundaries of the regions in the media are based on a center region of the media and/or a peripheral region around the center region. In some examples, the boundaries of the regions in the media are based on gaze data from the gaze tracking engine 270, and are based on a gaze region that the user is looking at according to the gaze tracking engine 270, and a peripheral region around the gaze region. The peripheral region may be in the user's peripheral vision, in some examples. The peripheral region may be outside of the user's field of view, in some examples.

In some examples, the semantic segmentation engine 230 can include ML systems, and/or trained ML models. In some examples, the semantic segmentation engine 230 can perform these semantic segmentation operations by inputting the media data, object detection data from the object detection engine 225, and/or gaze data from the gaze tracking engine 270 into the trained ML model(s), and receiving as outputs of the trained ML model(s) the different regions resulting from the semantic segmentation, or indications of the positions and/or boundaries of the regions. The ML system(s) and/or trained ML model(s) may include one or more NNs, one or more CNNs, one or more TDNNs, one or more deep networks, one or more autoencoders, one or more DBNs, one or more RNNs, one or more GANs, one or more trained SVMs, one or more trained RFs, one or more deep learning systems, or combinations thereof. In some examples, the semantic segmentation engine 230 generates a confidence level associated with the semantic segmentation into the regions. In some examples, the semantic segmentation engine 230 outputs the regions, or the indications thereof, if the confidence level meets or exceeds a predetermined confidence level threshold.

In some examples, semantic segmentation engine 230 receives gaze data from the gaze tracking engine 270, and uses the gaze data as an input to the ML systems and/or trained ML model(s) of the semantic segmentation engine 230. If the gaze data indicates that the user is looking at a particular region of the environment, the semantic segmentation engine 230 can segment the media to have that region be, include, or be included by, one of the regions that the semantic segmentation engine 230 segments the media into. In some examples, if the gaze data indicates that the user is looking at a particular region of the environment, the semantic segmentation engine 230 can reduce a confidence threshold of the semantic segmentation engine 230 for semantic segmentation based on that region of the environment.

In some examples, semantic segmentation engine 230 can receive data from the object detection engine 225 about, and can divide the media into the segments based on, detection of region(s) of the environment that one or more hands or feet of the user are holding, touching, pointing toward, gesturing toward, or a combination thereof. For example, the semantic segmentation engine 230 can divide the media into a first region and a second region. The first region includes the region(s) of the environment that one or more hands or feet of the user are holding, touching, pointing toward, gesturing toward, or a combination thereof. The second region lacks (does not include and/or is missing) the region(s) of the environment that one or more hands or feet of the user are holding, touching, pointing toward, gesturing toward, or a combination thereof.

In some examples, the semantic segmentation engine 230 includes a software element, such as a set of instructions corresponding to a program, that is run on a processor such as the processor 1110 of the computing system 1100, the image processor 150, the host processor 152, the ISP 154, or a combination thereof. In some examples, the semantic segmentation engine 230 includes one or more hardware elements. For instance, the semantic segmentation engine 230 can include a processor such as the processor 1110 of the computing system 1100, the image processor 150, the host processor 152, the ISP 154, or a combination thereof. In some examples, the semantic segmentation engine 230 includes a combination of one or more software elements and one or more hardware elements.

The media processing system 200 includes a media modification engine 235. The media modification engine 235 modifies media before the media is output using the output device(s) 240 and/or the transceiver(s) 245 of the media processing system 200. The media modified by the media modification engine 235 may include the media captured by the environment-facing sensor(s) 210, the virtual content generated by the virtual content generator 215, and/or the combined media generated by the compositor 220. The media modification engine 235 can modify portion(s) of the media to obscure and/or attenuate the portion(s) of the media, in some cases without obscuring and/or attenuating other portion(s) of the media. The portion(s) of the media can be referred to as regions, subsets, areas, and/or aspects of the media.

The media modification engine 235 can modify one or more first region(s) of visual media data (e.g., image(s), video(s)) of the media without modifying one or more second region(s) of the media, for instance based on information from the semantic segmentation engine 230, the object detection engine 225, or both. For instance, the media modification engine 235 can modify the first region(s) of the visual media data to obscure the first region(s) of the visual media data, without obscuring the second region(s) of the visual media data. The first region(s) and second region(s) can be identified using the object detection engine 225 and/or the semantic segmentation engine 230. In one illustrative example, the first region(s) include one or more feature(s), object(s), face(s), person(s), animal(s), device(s), and/or vehicle(s) detected in the media by the object detection engine 225, while the second region(s) lack (do not include) such detection(s). In another illustrative example, the second region(s) include one or more feature(s), object(s), face(s), person(s), animal(s), device(s), and/or vehicle(s) detected in the media by the object detection engine 225, while the first region(s) lack (do not include) such detection(s). Thus, in some examples, the media modification engine 235 obscures a region that includes a detected feature(s), object(s), face(s), person(s), animal(s), device(s), and/or vehicle(s), while leaving other regions unobscured. In some examples, the media modification engine 235 leaves a region unobscured that includes a detected feature(s), object(s), face(s), person(s), animal(s), device(s), and/or vehicle(s), while obscuring other regions.

The media modification engine 235 can obscure region(s) of visual media data of the media in various ways. For instance, the media modification engine 235 can obscure region(s) of visual media data by blurring the region(s), scrambling the region(s), pixelizing the region(s), pixelating the region(s), mosaicking the region(s), cropping out the region(s), compressing the region(s) more heavily than other region(s) of the visual media data using image compression and/or video compression techniques, reducing image resolution of the region(s) relative to the resolution of other region(s) of the visual media data, quantization of the region(s) more heavily than other region(s) of the visual media data during image compression and/or video compression, removing the region(s), replacing the region(s) with other data (e.g., a color, a pattern, another image), inpainting the region(s) (e.g., using interpolation based on one or more surrounding pixels and/or regions), or a combination thereof. In some examples, the media modification engine 235 can obscure region(s) of visual media data with a clear, sharp boundary between the obscured region and the unobscured region. In some examples, the media modification engine 235 can obscure region(s) of visual media data with a gradual, gradient boundary between the obscured region and the unobscured region, for instance as illustrated in

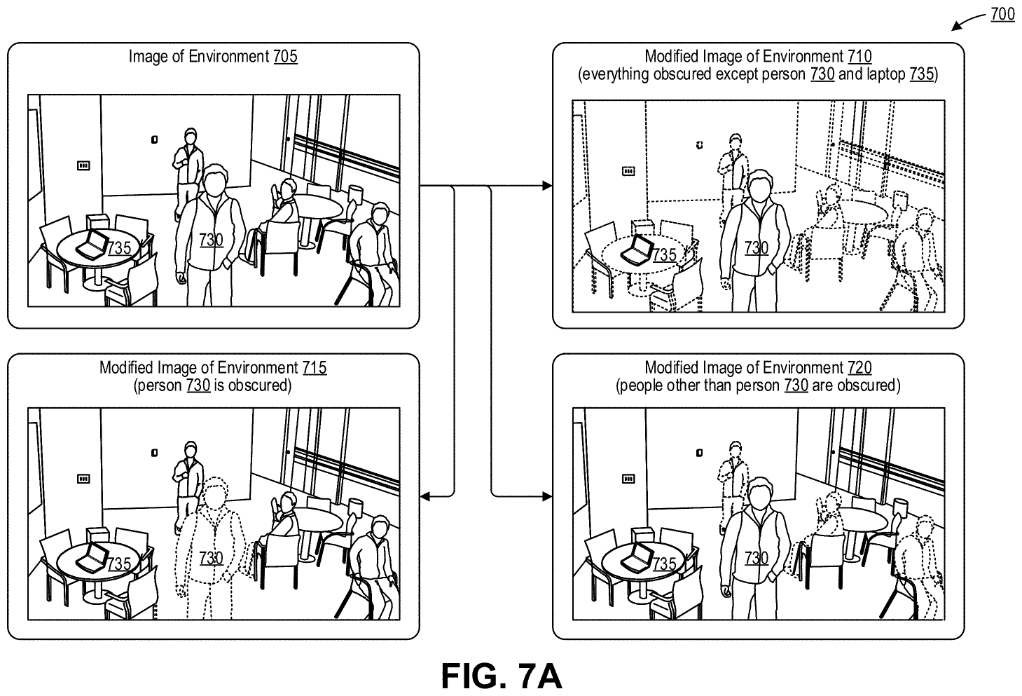

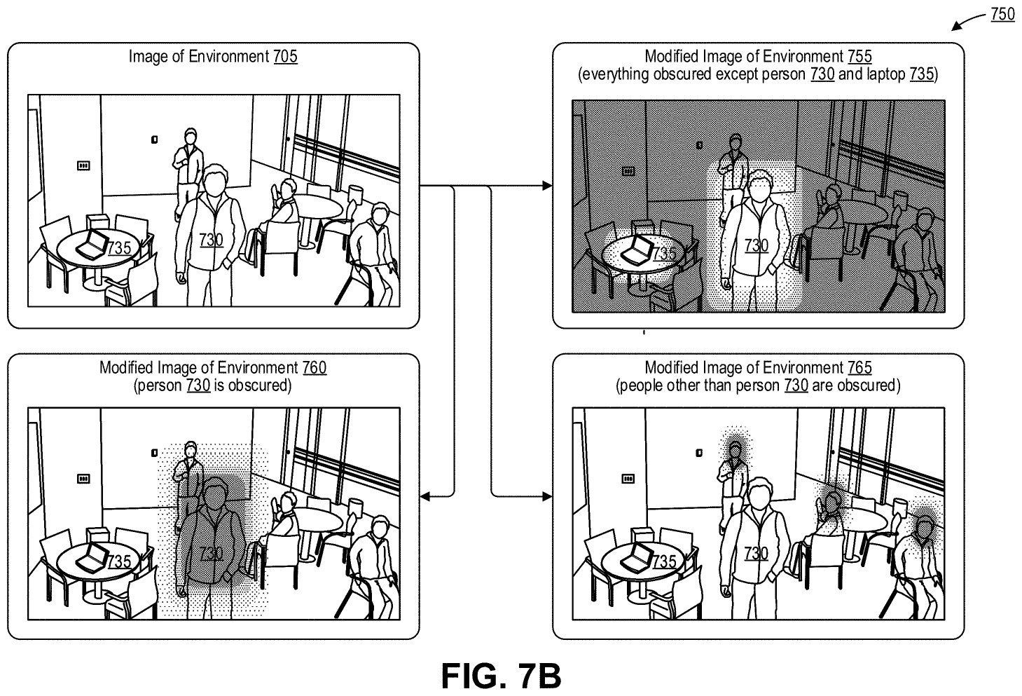

FIG. 7B. In some examples, the media modification engine 235 can obscure region(s) of visual media data using foveated compression, foveated blurring, foveated resolution reduction, foveated pixelization, foveated shading, other foveated image processing, or combinations thereof. For instance, in the embodiments where the media modification engine 235 can modify one or more first region(s) of visual media data (e.g., image(s), video(s)) of the media without modifying one or more second region(s) of the visual media data, the one or more second region(s) may include a fixation point, for example, fixation(s) by the user 205's eye(s) determined by the gaze tracking engine 270 which will be described in detail below, while the one or more first region(s) may include a peripheral area around the fixation point, and in this case, the media modification engine 235 can modify the visual media data to obscure the one or more first region(s) by modifying the visual media data using foveated compression of the peripheral area around the fixation point. Within FIG. 2, the semantic segmentation engine 230 are illustrated as pixelizing and/or pixelating the house and the tetrahedron (the virtual content), but not the person.

In some examples, use of increased compression, increased quantization, resolution reduction, cropping, and/or pixelization of region(s) of the media to obscure region(s) of the visual media data can result in bandwidth savings, storage space savings, and/or power savings. For instance, the modified media may require less data (e.g., smaller number of bits) to store and/or send, and thus bandwidth may be saved in transferring the media within the media processing system 200 and/or from the media processing system 200 to a recipient device. The modified media may also require less energy to encode and/or decode, and thus power may be saved both on the encoding side (e.g., to store the modified media) and the decoding side (e.g., to display and/or play the modified media).

The media modification engine 235 can modify a first portion of audio media data of the media to attenuate, silence, and/or remove a first portion of the audio media data without attenuating, silencing, and/or removing a second portion of the audio media data, for instance based on information from the semantic segmentation engine 230, the object detection engine 225, or both. In some examples, the media modification engine 235 can attenuate, silence, and/or remove specific sound(s) corresponding to audio feature(s), object(s), voice(s), animal(s), device(s), and/or vehicle(s) from the audio media data, in response to detection of those sound(s) in the audio media data by the object detection engine 225 and/or semantic segmentation of those sound(s) from other audio in the audio media data by the semantic segmentation engine 230. For example, the media modification engine 235 can attenuate, silence, and/or remove a voice of a specific person from the audio media data in response to detection and/or recognition of the voice of that person in the audio media data by the object detection engine 225 and/or semantic segmentation of the voice of that person from other audio in the audio media data by the semantic segmentation engine 230.

In some examples, the media modification engine 235 can include ML systems, and/or trained ML models. In some examples, the media modification engine 235 can perform these modification operations by inputting the media data, object detection data from the object detection engine 225, semantic segmentation data from the semantic segmentation engine 230, and/or gaze data from the gaze tracking engine 270 into the trained ML model(s), and receiving as outputs of the trained ML model(s) the modification(s) to the portion(s) of the media, and/or the media modified with the modification(s) at the portion(s) to be modified. The ML system(s) and/or trained ML model(s) may include one or more NNs, one or more CNNs, one or more TDNNs, one or more deep networks, one or more autoencoders, one or more DBNs, one or more RNNs, one or more GANs, one or more trained SVMs, one or more trained RFs, one or more deep learning systems, or combinations thereof. In some examples, the media modification engine 235 generates a confidence level associated with the modification(s). In some examples, the media modification engine 235 outputs and/or makes the modification(s) to the media if the confidence level meets or exceeds a predetermined confidence level threshold.

In some examples, media modification engine 235 receives gaze data from the gaze tracking engine 270. In some examples, the media modification engine 235 can use the gaze data to determine whether to modify a particular region, or to leave the region unmodified. In some examples, the media modification engine 235 uses the gaze data as an input to the ML systems and/or trained ML model(s) of the media modification engine 235.

In some examples, the media modification engine 235 includes a software element, such as a set of instructions corresponding to a program, that is run on a processor such as the processor 1110 of the computing system 1100, the image processor 150, the host processor 152, the ISP 154, or a combination thereof. In some examples, the media modification engine 235 includes one or more hardware elements. For instance, the media modification engine 235 can include a processor such as the processor 1110 of the computing system 1100, the image processor 150, the host processor 152, the ISP 154, or a combination thereof. In some examples, the media modification engine 235 includes a combination of one or more software elements and one or more hardware elements.

As noted previously, the media processing system 200 includes output device(s) 240 that the media processing system 200 can use to output the media after modifying the media using the media modification engine 235, for instance by displaying visual media data of the media using display(s) of the output device(s) 240 and/or by playing audio media data of the media using audio output device(s) of the output device(s) 240. The media processing system 200 also includes one or more transceivers 245 that the media processing system 200 can use to output the media after modifying the media using the media modification engine 235, for instance by sending the media to a recipient device. The recipient device can output the media using its own output device(s), for instance by displaying visual media data of the media using display(s) of the output device(s) and/or by playing audio media data of the media using audio output device(s) of the output device(s). The transceiver(s) 245 may include wired or wireless transceiver(s), communication interface(s), antenna(e), connections, couplings, coupling systems, or combinations thereof. In some examples, the transceiver(s) 245 may include the communication interface 1140 of the computing system 1100. In some examples, the communication interface 1140 of the computing system 1100 may include the transceiver(s) 245. Within FIG. 2, the transceiver(s) 245 are illustrated as wireless transceiver(s) 245 sending media data, illustrated as including representations of the person, the house and the tetrahedron (the virtual content).

In some examples, the media processing system 200 includes a gaze tracking engine 270. The gaze tracking engine 270 can receive sensor data from the user-facing sensor(s) 205, and detects, recognizes, and/or tracks the user's gaze (e.g., where the user is looking, what in the environment and/or media the user is looking at), the user's facial expression(s), and/or the user's gestures, based on the sensor data. In some examples, the sensor data that the gaze tracking engine 270 receives from the user-facing sensor(s) 205 includes image(s) and/or video(s) of the eye(s) of the user. In some examples, the sensor data that the gaze tracking engine 270 receives from the user-facing sensor(s) 205 includes depth data (e.g., point clouds, depth images) of the eye(s) of the user. The gaze tracking engine 270 can detect, recognize, and/or track the user's gaze, the user's facial expression(s), and/or the user's gestures, based on one or more attributes of the user's eye(s) and/or face detected in the sensor data from the user-facing sensor(s) 205. The attributes can include, for example, position(s) of the user 205's eye(s), movement(s) of the user 205's eye(s), position(s) of the user 205's eyelid(s), movement(s) of the user 205's eyelid(s), position(s) of the user 205's eyebrow(s), movement(s) of the user 205's eyebrow(s), pupil dilation(s) of the user 205's eye(s), fixation(s) by the user 205's eye(s), eye moisture level(s) of the user 205's eye(s), blinking of the user 205's eyelid(s), squinting of the user 205's eyelid(s), saccade(s) of the user 205's eye(s), optokinetic reflex(es) of the user 205's eye(s), vestibulo-ocular reflex(es) of the user 205's eye(s), accommodation reflex(es) of the user 205's eye(s), or combinations thereof. Within FIG. 2, the gaze tracking engine 270 are illustrated as identifying both a direction that an eye of the user is looking (indicated by a solid black arrow) and an angle that the direction has changed over time (indicated by a curved dashed black arrow).

In some examples, the gaze tracking engine 270 can include ML systems, and/or trained ML models. In some examples, the gaze tracking engine 270 can perform gaze tracking operations by inputting sensor data from the user-facing sensor(s), for instance including image(s) of the user's eye(s), and/or media data (e.g., to determine what in the media data the user's gaze is looking toward) into the trained ML model(s). The gaze tracking engine 270 can receive, as outputs of the trained ML model(s), gaze data indicating where the user is looking, what in the media the user is looking at, various eye movements and/or other eye attributes, or a combination thereof. The ML system(s) and/or trained ML model(s) may include one or more NNs, one or more CNNs, one or more TDNNs, one or more deep networks, one or more autoencoders, one or more DBNs, one or more RNNs, one or more GANs, one or more trained SVMs, one or more trained RFs, one or more deep learning systems, or combinations thereof. In some examples, the gaze tracking engine 270 generates a confidence level associated with the gaze tracking. In some examples, the gaze tracking engine 270 outputs the gaze data if the confidence level meets or exceeds a predetermined confidence level threshold.

In some examples, the gaze tracking engine 270 includes a software element, such as a set of instructions corresponding to a program, that is run on a processor such as the processor 1110 of the computing system 1100, the image processor 150, the host processor 152, the ISP 154, or a combination thereof. In some examples, the gaze tracking engine 270 includes one or more hardware elements. For instance, the gaze tracking engine 270 can include a processor such as the processor 1110 of the computing system 1100, the image processor 150, the host processor 152, the ISP 154, or a combination thereof. In some examples, the gaze tracking engine 270 includes a combination of one or more software elements and one or more hardware elements.

In some examples, the media processing system 200 performs the modifications to the media using the media modification engine 235 based on object(s) detected by the object detection engine 225, semantic segmentation of the media by the semantic segmentation engine 230, and/or gaze data detected by the gaze tracking engine 270, to improve privacy. For instance, the environment-facing sensor(s) 210 may sometimes capture portions of the environment that include people or objects who may not be the intended focus of the media. Such people may, in some cases, have not consented to appear in the media. This may be of particular concern if the media processing system 200 is an XR device and/or a live-streaming device, which may increase the probability of the environment-facing sensor(s) 210 may capturing portions of the environment that include such people or objects. This is because XR devices can often be the primary lens through which a user views their environment, and thus the user may accidentally turn their XR device towards someone or something without realizing what the user is turning the XR device toward. Live-streaming devices often have little or no delay between capture and sending of their respective media, which leaves little or no recourse if unintended or unwanted people or objects appear in the environment that the environment-facing sensor(s) 210 capture. Use of the modifications by the media modification engine 235 can limit the people or objects that appear clearly in the media to only those people or objects on an approved list (e.g., a whitelist) and/or to those people or objects that do not appear on a block list (e.g., a blacklist).

Use of the modifications by the media modification engine 235 can obscure and/or attenuate visual and/or audio portions of the media corresponding to people or objects that appear on a block list (e.g., a blacklist), or that do not appear on an approved list (e.g., a whitelist). Thus, the modifications to the media by the media modification engine 235 provide powerful and nearly instantaneous privacy enhancements that are useful for situations where a user would have insufficient time to perform any media editing.

In some examples, the media processing system 200 performs the modifications using the media modification engine 235 based on the identifies of certain people or objects detected, for instance based on whether those identities appear on an approved list (e.g., a whitelist) or a block list (e.g., a blacklist). In some examples, the approved list and/or the block list may be based on information from a message, an email, an event invitation, a schedule, a calendar, a contact list, or a combination thereof. In some examples, the approved list may be automatically generated by the media processing system 200 to include invitees to an event that appears on a calendar, schedule. In some examples, the block list may be automatically generated by the media processing system 200 to include anyone not invited to the event. In some examples, the opposite is true, as the event invitees are on the block list and/or non-invitees are on the approved list. In some examples, the approved list may be automatically generated by the media processing system 200 to include people to whom a message was sent, such as people who appear in a “to” field, a “cc” field, and/or a “bcc” field in an email. In some examples, the block list may be automatically generated by the media processing system 200 to include anyone who the message was not sent to. In some examples, the opposite is true, as the message recipients are on the block list and/or non-recipients are on the approved list. In some examples, the approved list, may be automatically generated by the media processing system 200 to include a single person, such as the sender of a message or email, or the host of an event, and/or anyone else is placed on the block list. In some examples, the opposite is true, as the single person is on the block list and/or others are on the approved list.

In some examples, the media processing system 200 can use its object detection engine 225 in two passes. For instance, the object detection engine 225 can perform a preliminary, coarse pass to determine if a type of object, or sounds associated with the type of object, are present at all in the media. For instance, the object detection engine 225 can determine if any faces are present in the visual media data, and/or if any voices are present in the audio media data. If the object detection engine 225 detects presence of the type of object, or sounds associated with the type of object, in the preliminary, coarse pass, the object detection engine 225 can perform a more detailed pass. For instance, if the first pass of the object detection engine 225 determines that one or more faces are present in the visual media data, and/or determines that one or more voices are present in the audio media data, then the object detection engine 225 can perform a more detailed pass to determine if the object detection engine 225 recognizes any of the detected faces, and/or if the object detection engine 225 recognizes any of the detected voices.

In some examples, the media processing system 200 includes a feedback engine 260. The feedback engine 260 can detect feedback received from the user interface. The feedback engine 260 can detect feedback about one engine of the media processing system 200 received from another engine of the media processing system 200, for instance whether one engine decides to use data from the other engine or not. The feedback can be feedback regarding the compositing by the compositor 220, the object detection by the object detection engine 225, the sematic segmentation by the sematic segmentation engine 230, the media modification by the media modification engine 235, the gaze tracking by the gaze tracking engine 270, or a combination thereof. The feedback received by the feedback engine 260 can be positive feedback or negative feedback. For instance, if the one engine of the media processing system 200 uses data from another engine of the media processing system 200, the feedback engine 260 can interpret this as positive feedback. If the one engine of the media processing system 200 declines to data from another engine of the media processing system 200, the feedback engine 260 can interpret this as negative feedback. Positive feedback can also be based on attributes of the sensor data from the user-facing sensor(s) 205, such as the user smiling, laughing, nodding, saying a positive statement (e.g., “yes,” “confirmed,” “okay,” “next”), or otherwise positively reacting to the media. Negative feedback can also be based on attributes of the sensor data from the user-facing sensor(s) 205, such as the user frowning, crying, shaking their head (e.g., in a “no” motion), saying a negative statement (e.g., “no,” “negative,” “bad,” “not this”), or otherwise negatively reacting to the virtual content.

In some examples, the feedback engine 260 provides the feedback to one or more ML systems of the media processing system 200 as training data to update the one or more ML systems of the media processing system 200. For instance, the feedback engine 260 can provide the feedback as training data to the ML system(s) and/or the trained ML model(s) of the compositor 220, the object detection engine 225, the semantic segmentation engine 230, the media modification engine 235, and/or the gaze tracking engine 270. Positive feedback can be used to strengthen and/or reinforce weights associated with the outputs of the ML system(s) and/or the trained ML model(s). Negative feedback can be used to weaken and/or remove weights associated with the outputs of the ML system(s) and/or the trained ML model(s).

In some examples, the feedback engine 260 includes a software element, such as a set of instructions corresponding to a program, that is run on a processor such as the processor 1110 of the computing system 1100, the image processor 150, the host processor 152, the ISP 154, or a combination thereof. In some examples, the feedback engine 260 includes one or more hardware elements. For instance, the feedback engine 260 can include a processor such as the processor 1110 of the computing system 1100, the image processor 150, the host processor 152, the ISP 154, or a combination thereof. In some examples, the feedback engine 260 includes a combination of one or more software elements and one or more hardware elements.

In some examples, the media processing system 200 can change the segmentation of the environment by the semantic segmentation engine 230, and/or which portion(s) the media receive the obscuring and/or attenuating modification from the media modification engine 235, based on the gaze of the user (e.g., as detected by the gaze tracking engine 270), based on gestures by the user (e.g., as detected by the gaze tracking engine 270 and/or the object detection engine 225), based on command(s) spoken by the user (e.g., “blur this,” “obscure this,” “don't blur that,” “don't obscure that”), or combination thereof

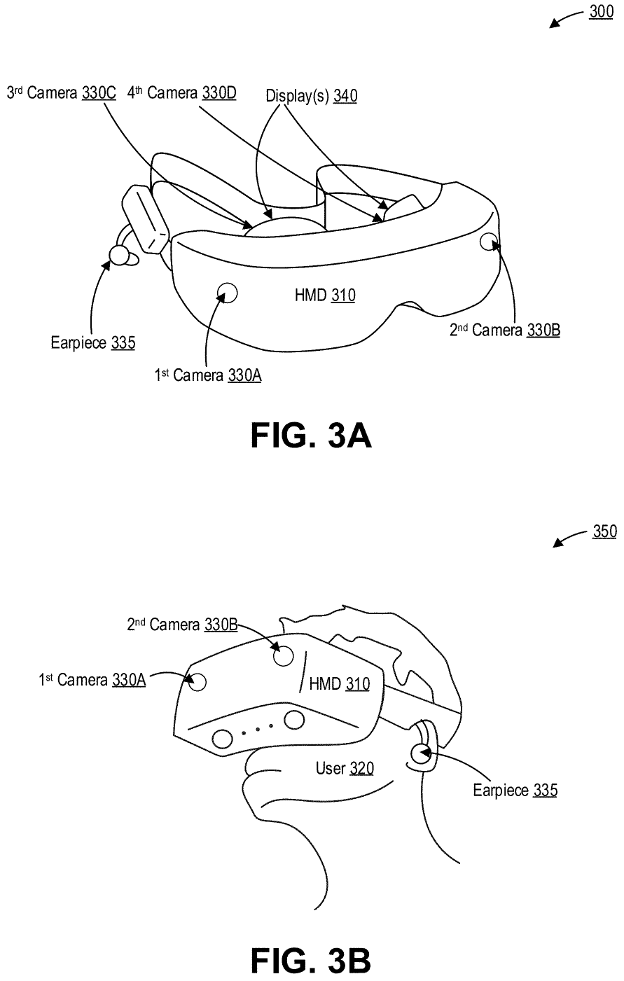

FIG. 3A is a perspective diagram 300 illustrating a head-mounted display (HMD) 310 that is used as an extended reality (XR) system 200. The HMD 310 may be, for example, an augmented reality (AR) headset, a virtual reality (VR) headset, a mixed reality (MR) headset, an extended reality (XR) headset, or some combination thereof. The HMD 310 may be an example of a media processing system 200. The HMD 310 includes a first camera 330A and a second camera 330B along a front portion of the HMD 310. The first camera 330A and the second camera 330B may be examples of the environment-facing sensors 210 of the media processing system 200. The HMD 310 includes a third camera 330C and a fourth camera 330D facing the eye(s) of the user as the eye(s) of the user face the display(s) 340. The third camera 330C and the fourth camera 330D may be examples of the user-facing sensors 205 of the media processing system 200. In some examples, the HMD 310 may only have a single camera with a single image sensor. In some examples, the HMD 310 may include one or more additional cameras in addition to the first camera 330A, the second camera 330B, third camera 330C, and the fourth camera 330D. In some examples, the HMD 310 may include one or more additional sensors in addition to the first camera 330A, the second camera 330B, third camera 330C, and the fourth camera 330D, which may also include other types of user-facing sensors 205 and/or environment-facing sensors 210 of the media processing system 200. In some examples, the first camera 330A, the second camera 330B, third camera 330C, and/or the fourth camera 330D may be examples of the image capture and processing system 100, the image capture device 105A, the image processing device 105B, or a combination thereof.

The HMD 310 may include one or more displays 340 that are visible to a user 320 wearing the HMD 310 on the user 320's head. The one or more displays 340 of the HMD 310 can be examples of the one or more displays of the output device(s) 240 of the media processing system 200. In some examples, the HMD 310 may include one display 340 and two viewfinders. The two viewfinders can include a left viewfinder for the user 320's left eye and a right viewfinder for the user 320's right eye. The left viewfinder can be oriented so that the left eye of the user 320 sees a left side of the display. The right viewfinder can be oriented so that the right eye of the user 320 sees a right side of the display. In some examples, the HMD 310 may include two displays 340, including a left display that displays content to the user 320's left eye and a right display that displays content to a user 320's right eye. The one or more displays 340 of the HMD 310 can be digital “pass-through” displays or optical “see-through” displays.

The HMD 310 may include one or more earpieces 335, which may function as speakers and/or headphones that output audio to one or more ears of a user of the HMD 310. One earpiece 335 is illustrated in FIGS. 3A and 3B, but it should be understood that the HMD 310 can include two earpieces, with one earpiece for each ear (left ear and right ear) of the user. In some examples, the HMD 310 can also include one or more microphones (not pictured). The one or more microphones can be examples of the user-facing sensors 205 and/or environment-facing sensors 210 of the media processing system 200. In some examples, the audio output by the HMD 310 to the user through the one or more earpieces 335 may include, or be based on, audio recorded using the one or more microphones.

FIG. 3B is a perspective diagram 350 illustrating the head-mounted display (HMD) of FIG. 3A being worn by a user 320. The user 320 wears the HMD 310 on the user 320's head over the user 320's eyes. The HMD 310 can capture images with the first camera 330A and the second camera 330B. In some examples, the HMD 310 displays one or more output images toward the user 320's eyes using the display(s) 340. In some examples, the output images can include the virtual content generated by the virtual content generator 215, composited using the compositor 220, and/or displayed by the display(s) of the output device(s) 240. The output images can be based on the images captured by the first camera 330A and the second camera 330B, for example with the virtual content overlaid. The output images may provide a stereoscopic view of the environment, in some cases with the virtual content overlaid and/or with other modifications. For example, the HMD 310 can display a first display image to the user 320's right eye, the first display image based on an image captured by the first camera 330A. The HMD 310 can display a second display image to the user 320's left eye, the second display image based on an image captured by the second camera 330B. For instance, the HMD 310 may provide overlaid virtual content in the display images overlaid over the images captured by the first camera 330A and the second camera 330B. The third camera 330C and the fourth camera 330D can capture images of the eyes of the before, during, and/or after the user views the display images displayed by the display(s) 340. This way, the sensor data from the third camera 330C and/or the fourth camera 330D can capture reactions to the virtual content by the user's eyes (and/or other portions of the user). An earpiece 335 of the HMD 310 is illustrated in an ear of the user 320. The HMD 310 may be outputting audio to the user 320 through the earpiece 335 and/or through another earpiece (not pictured) of the HMD 310 that is in the other ear (not pictured) of the user 320.

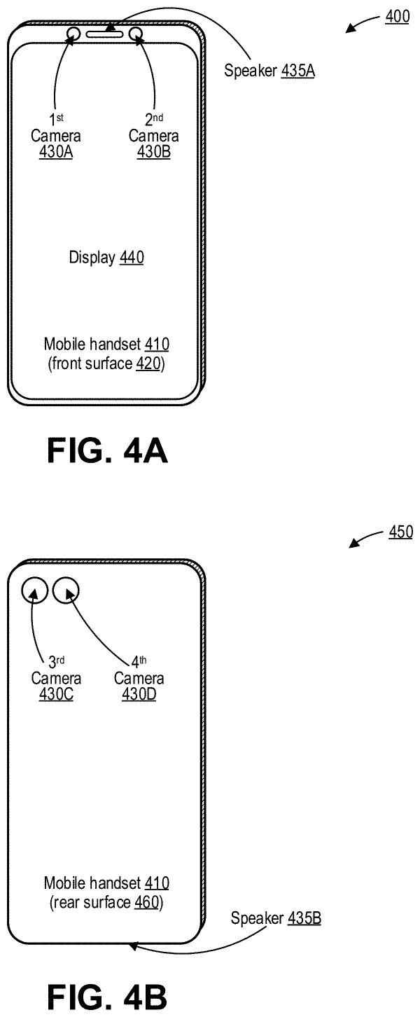

FIG. 4A is a perspective diagram 400 illustrating a front surface of a mobile handset 410 that includes front-facing cameras and can be used as an extended reality (XR) system 200. The mobile handset 410 may be an example of a media processing system 200. The mobile handset 410 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 420 of the mobile handset 410 includes a display 440. The front surface 420 of the mobile handset 410 includes a first camera 430A and a second camera 430B. The first camera 430A and the second camera 430B may be examples of the user-facing sensors 205 of the media processing system 200. The first camera 430A and the second camera 430B can face the user, including the eye(s) of the user, while content (e.g., the modified media output by the media modification engine 235) is displayed on the display 440. The display 440 may be an example of the display(s) of the output device(s) 240 of the media processing system 200.

The first camera 430A and the second camera 430B are illustrated in a bezel around the display 440 on the front surface 420 of the mobile handset 410. In some examples, the first camera 430A and the second camera 430B can be positioned in a notch or cutout that is cut out from the display 440 on the front surface 420 of the mobile handset 410. In some examples, the first camera 430A and the second camera 430B can be under-display cameras that are positioned between the display 440 and the rest of the mobile handset 410, so that light passes through a portion of the display 440 before reaching the first camera 430A and the second camera 430B. The first camera 430A and the second camera 430B of the perspective diagram 400 are front-facing cameras. The first camera 430A and the second camera 430B face a direction perpendicular to a planar surface of the front surface 420 of the mobile handset 410. The first camera 430A and the second camera 430B may be two of the one or more cameras of the mobile handset 410. In some examples, the front surface 420 of the mobile handset 410 may only have a single camera.

In some examples, the front surface 420 of the mobile handset 410 may include one or more additional cameras in addition to the first camera 430A and the second camera 430B. The one or more additional cameras may also be examples of the user-facing sensors 205 of the media processing system 200. In some examples, the front surface 420 of the mobile handset 410 may include one or more additional sensors in addition to the first camera 430A and the second camera 430B. The one or more additional sensors may also be examples of the user-facing sensors 205 of the media processing system 200. In some cases, the front surface 420 of the mobile handset 410 includes more than one display 440. The one or more displays 440 of the front surface 420 of the mobile handset 410 can be examples of the display(s) of the output device(s) 240 of the media processing system 200. For example, the one or more displays 440 can include one or more touchscreen displays.

The mobile handset 410 may include one or more speakers 435A and/or other audio output devices (e.g., earphones or headphones or connectors thereto), which can output audio to one or more ears of a user of the mobile handset 410. One speaker 435A is illustrated in FIG. 4A, but it should be understood that the mobile handset 410 can include more than one speaker and/or other audio device. In some examples, the mobile handset 410 can also include one or more microphones (not pictured). The one or more microphones can be examples of the user-facing sensors 205 and/or of the environment-facing sensors 210 of the media processing system 200. In some examples, the mobile handset 410 can include one or more microphones along and/or adjacent to the front surface 420 of the mobile handset 410, with these microphones being examples of the user-facing sensors 205 of the media processing system 200. In some examples, the audio output by the mobile handset 410 to the user through the one or more speakers 435A and/or other audio output devices may include, or be based on, audio recorded using the one or more microphones.

FIG. 4B is a perspective diagram 450 illustrating a rear surface 460 of a mobile handset that includes rear-facing cameras and that can be used as an extended reality (XR) system 200. The mobile handset 410 includes a third camera 430C and a fourth camera 430D on the rear surface 460 of the mobile handset 410. The third camera 430C and the fourth camera 430D of the perspective diagram 450 are rear-facing. The third camera 430C and the fourth camera 430D may be examples of the environment-facing sensors 210 of the media processing system 200 of FIG. 2. The third camera 430C and the fourth camera 430D face a direction perpendicular to a planar surface of the rear surface 460 of the mobile handset 410.

The third camera 430C and the fourth camera 430D may be two of the one or more cameras of the mobile handset 410. In some examples, the rear surface 460 of the mobile handset 410 may only have a single camera. In some examples, the rear surface 460 of the mobile handset 410 may include one or more additional cameras in addition to the third camera 430C and the fourth camera 430D. The one or more additional cameras may also be examples of the environment-facing sensors 210 of the media processing system 200. In some examples, the rear surface 460 of the mobile handset 410 may include one or more additional sensors in addition to the third camera 430C and the fourth camera 430D. The one or more additional sensors may also be examples of the environment-facing sensors 210 of the media processing system 200. In some examples, the first camera 430A, the second camera 430B, third camera 430C, and/or the fourth camera 430D may be examples of the image capture and processing system 100, the image capture device 105A, the image processing device 105B, or a combination thereof.

The mobile handset 410 may include one or more speakers 435B and/or other audio output devices (e.g., earphones or headphones or connectors thereto), which can output audio to one or more ears of a user of the mobile handset 410. One speaker 435B is illustrated in FIG. 4B, but it should be understood that the mobile handset 410 can include more than one speaker and/or other audio device. In some examples, the mobile handset 410 can also include one or more microphones (not pictured). The one or more microphones can be examples of the user-facing sensors 205 and/or of the environment-facing sensors 210 of the media processing system 200. In some examples, the mobile handset 410 can include one or more microphones along and/or adjacent to the rear surface 460 of the mobile handset 410, with these microphones being examples of the environment-facing sensors 210 of the media processing system 200. In some examples, the audio output by the mobile handset 410 to the user through the one or more speakers 435B and/or other audio output devices may include, or be based on, audio recorded using the one or more microphones.

The mobile handset 410 may use the display 440 on the front surface 420 as a pass-through display. For instance, the display 440 may display output images. The output images can be based on the images captured by the third camera 430C and/or the fourth camera 430D, for example with the virtual content overlaid and/or with modifications by the media modification engine 235 applied. The first camera 430A and/or the second camera 430B can capture images of the user's eyes (and/or other portions of the user) before, during, and/or after the display of the output images with the virtual content on the display 440. This way, the sensor data from the first camera 430A and/or the second camera 430B can capture reactions to the virtual content by the user's eyes (and/or other portions of the user).

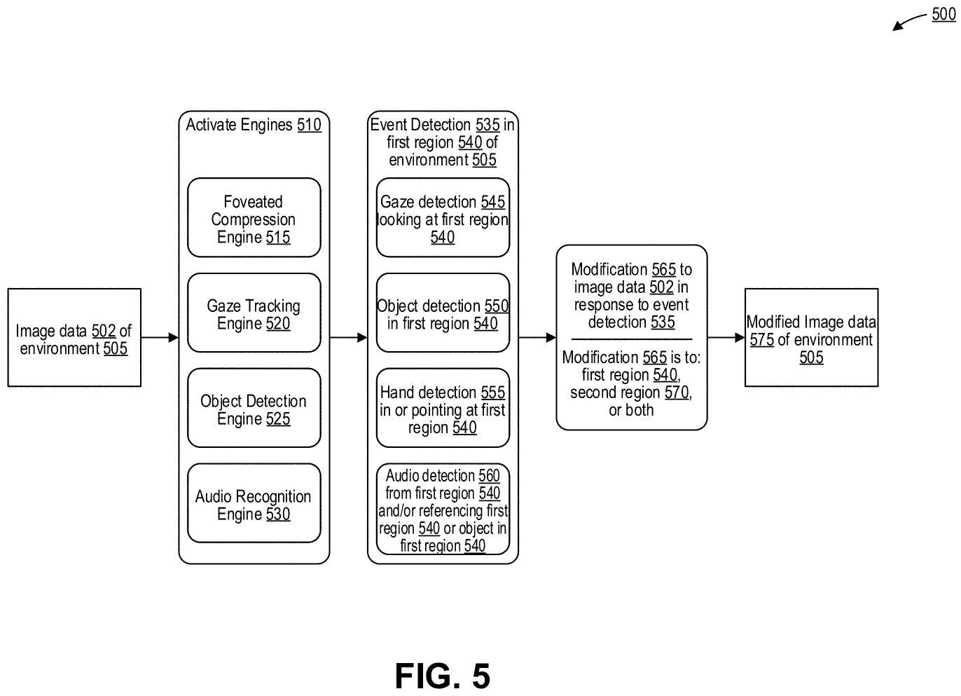

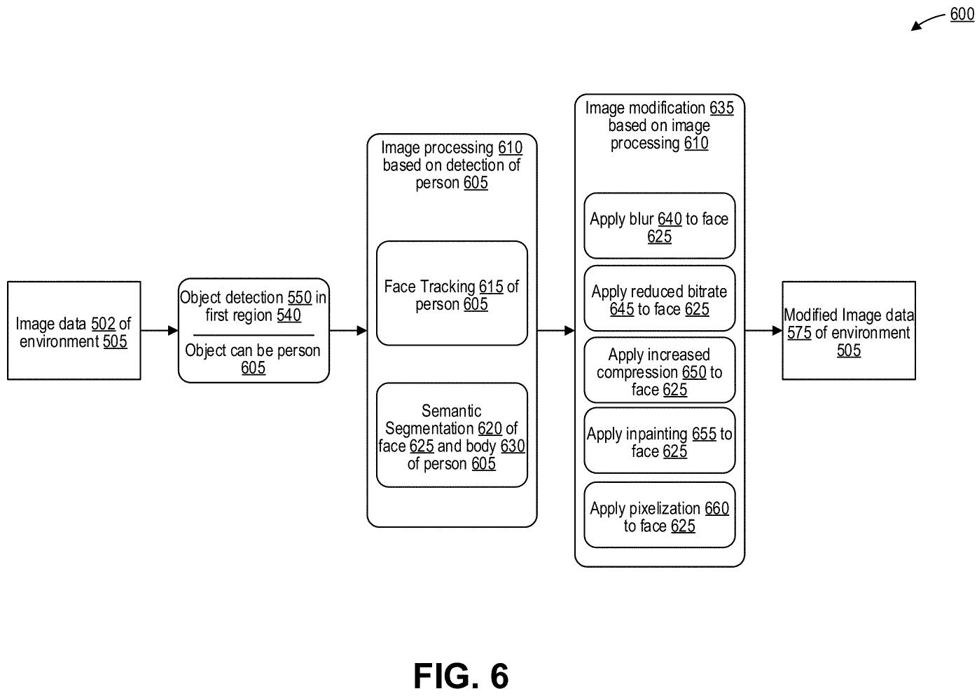

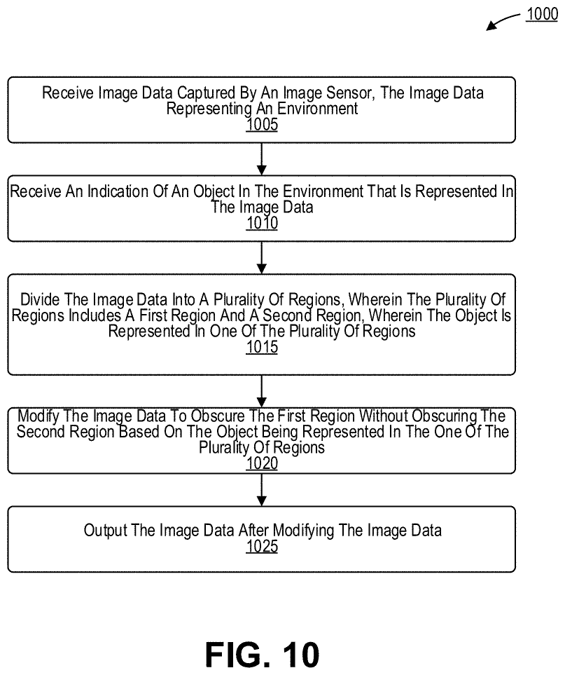

FIG. 5 is a block diagram illustrating a process 500 for image processing based on an event. The process 500 is performed by a media processing system, such as the media processing system 200, the media processing system of FIG. 6, and/or the media processing system of FIG. 10. The process 500 begins with image data 502 of an environment 505 being captured (e.g., by environment-facing sensor(s) 210) and/or received by the media processing system. The media processing system activates several media processing engines 510, such as a foveated compression engine 515 (which may be part of the media modification engine 235 that obscures using foveated compression), a gaze tracking engine 520 (which may be an example of the gaze tracking engine 270), an object detection engine 525 (which may be an example of the object detection engine 225 or an aspect thereof), and an audio recognition engine 530 (which may be an example of the object detection engine 225 or an audio aspect thereof).

The media processing system may perform an event detection 535 in a first region 540 of the environment 505. The event detection 535 may include gaze detection 545 of the user's gaze looking at the first region 540 (using the gaze tracking engine 520), object detection 550 in the first region 540 (using the object detection engine 525), hand detection 555 of the user's hand in or pointing at the first region 540 (using the object detection engine 525), audio detection 560 of audio coming from the first region 540 and/or referencing the first region 540 or an object in the first region 540 (using the audio recognition engine 530), or a combination thereof. In response to the event detection 535, the media processing system can perform a modification 565 of the image data 502 (e.g., using the media modification engine 235). The modification 565 can modify the first region 540 without modifying a second region 570 that is distinct from the first region 540, modify the second region 570 without modifying the first region 540, modify both the first region 540 and the second region 570 etc. The media processing system outputs the modified image data 575 of the environment 505 for example, by displaying the modified image data 575, playing audio corresponding to the modified image data 575, and/or transmitting the modified image data 575 to a recipient device using a communication transceiver.

FIG. 6 is a block diagram illustrating a process 600 for image processing based on detection of a person in image data. The process 600 is performed by a media processing system, such as the media processing system 200, the media processing system of FIG. 5, and/or the media processing system of FIG. 10. The process 500 begins with image data 502 of an environment 505 being captured (e.g., by environment-facing sensor(s) 210) and/or received by the media processing system. The media processing system performs object detection 550 to detect an object in the first region 540, for instance using the object detection engine 225 and/or the object detection engine 525. In some examples, the object is a person 605.

The media processing system performs image processing 610 based on detection of the person 605 (or other object). The image processing 610 can include face detection, recognition, and/or tracking 615 of the person 605. The image processing 610 can include semantic segmentation 620 of the face 625 and body 630 of the person 605. For instance, the face 625 and the body 630 of the person 605. The media processing system generates the modified image data 575 based on the image modification 635, and outputs the modified image data 575. The media processing system outputs the modified image data 575 of the environment 505 for example, by displaying the modified image data 575, playing audio corresponding to the modified image data 575, and/or transmitting the modified image data 575 to a recipient device using a communication transceiver.

The media processing system performs image modification 635 based on the image processing 610, for instance by applying blur 640 to the face 625, applying reduced bitrate 645 to the face 625, applying increase compression 650 to the face 625, applying inpainting 655 to the face 625, applying pixelization 660 to the face 625, or a combination thereof.

FIG. 7A is a conceptual diagram 700 illustrating examples of an image of an environment 705 and various modifications to the image to obscure portions of the environment indicated using dashed lines. The image of the environment 705 depicts a room with four people and a laptop 735. The four people include a person 730 and three other people. The image of the environment 705 is processed by a media processing system, such as the media processing system 200, the media processing system of FIG. 5, and/or the media processing system of FIG. 6. The image of the environment 705 is processed by a media processing system to generate the modified image of the environment 710, the modified image of the environment 715, and/or the modified image of the environment 720. Portions of the modified image of the environment 710, the modified image of the environment 715, and the modified image of the environment 720 that are obscured are illustrated with dashed black lines. Portions of the modified image of the environment 710, the modified image of the environment 715, and the modified image of the environment 720 that are unobscured are illustrated with solid black lines.

In the modified image of the environment 710, everything other than the person 730 and the laptop 735 in the room is obscured by the media modification engine 235. In some examples, the person 730 and the laptop 735 appear on an approved list (e.g., a whitelist) and/or everything else in the room appears on a blocked list (e.g., a blacklist).

In the modified image of the environment 715, the person 730 is obscured by the media modification engine 235, while everything else in the room (including the three other people and the laptop) remains unobscured. In some examples, the person 730 appears on the blocked list (e.g., blacklist) and/or everything else in the room appears on an approved list (e.g., a whitelist).

In the modified image of the environment 720, the three people other than the person 730 are obscured by the media modification engine 235, while everything else in the room (including the person 730 and the laptop 735) remains unobscured. In some examples, the person 730 appears on the approved list (e.g., a whitelist) and/or all other people other than the person 730 are on a blocked list (e.g., a blacklist).

FIG. 7B is a conceptual diagram 750 illustrating examples of the image of the environment 705 and various modifications to the image to obscure portions of the environment indicated using shading. In FIG. 7B, the image of the environment 705 is processed by a media processing system to generate the modified image of the environment 755, the modified image of the environment 760, and/or the modified image of the environment 765. In the modified image of the environment 755, the modified image of the environment 760, and/or the modified image of the environment 765, regions are obscured using a gradual, gradient, and/or foveated obscuring technique. Regions shaded using a darker shading patterns in FIG. 7B are more heavily obscured (e.g., more heavily blurred, compressed, pixelized, pixelated, mosaicked, darkened, brightened, inpainted, scrambled, and/or resolution-reduced), while regions shaded using a lighter shading pattern in FIG. 7B are less obscured or remain unobscured.

In the modified image of the environment 755, everything other than the person 730 and the laptop 735 in the room is obscured by the media modification engine 235. In some examples, the person 730 and the laptop 735 appear on an approved list (e.g., a whitelist) and/or everything else in the room appears on a blocked list (e.g., a blacklist).The obscuring is gradual, with parts of the environment around the person 730 and the laptop 735 remaining unobscured or less obscured than other parts of the environment.

In the modified image of the environment 760, the person 730 is obscured by the media modification engine 235, while everything else in the room (including the three other people and the laptop) remains unobscured. In some examples, the person 730 appears on the blocked list (e.g., blacklist) and/or everything else in the room appears on a blocked list (e.g., a blacklist). The obscuring is gradual, with parts of the environment around the person 730 being obscured more than other parts of the environment.

In the modified image of the environment 765, the faces of the three people other than the person 730 are obscured by the media modification engine 235, while everything else in the room (including the person 730 and the laptop 735) remains unobscured. In some examples, the person 730 appears on the approved list (e.g., a whitelist) and/or all other people other than the person 730 are on a blocked list (e.g., a blacklist). The obscuring is gradual, with parts of the environment around the faces of the three people other than the person 730 being obscured more than other parts of the environment.

As indicated above, the obscuring of region(s) in FIGS. 7A-7B can include blurring the region(s), pixelizing the region(s), pixelating the region(s), mosaicking the region(s), cropping out the region(s), compressing the region(s) more heavily than other region(s) of the visual media data using image compression and/or video compression techniques, reducing image resolution of the region(s) relative to the resolution of other region(s) of the visual media data, quantization of the region(s) more heavily than other region(s) of the visual media data during image compression and/or video compression, removing the region(s), replacing the region(s) with other data (e.g., a color, a pattern, another image), inpainting the region(s) (e.g., using interpolation based on one or more surrounding pixels and/or regions), or a combination thereof.

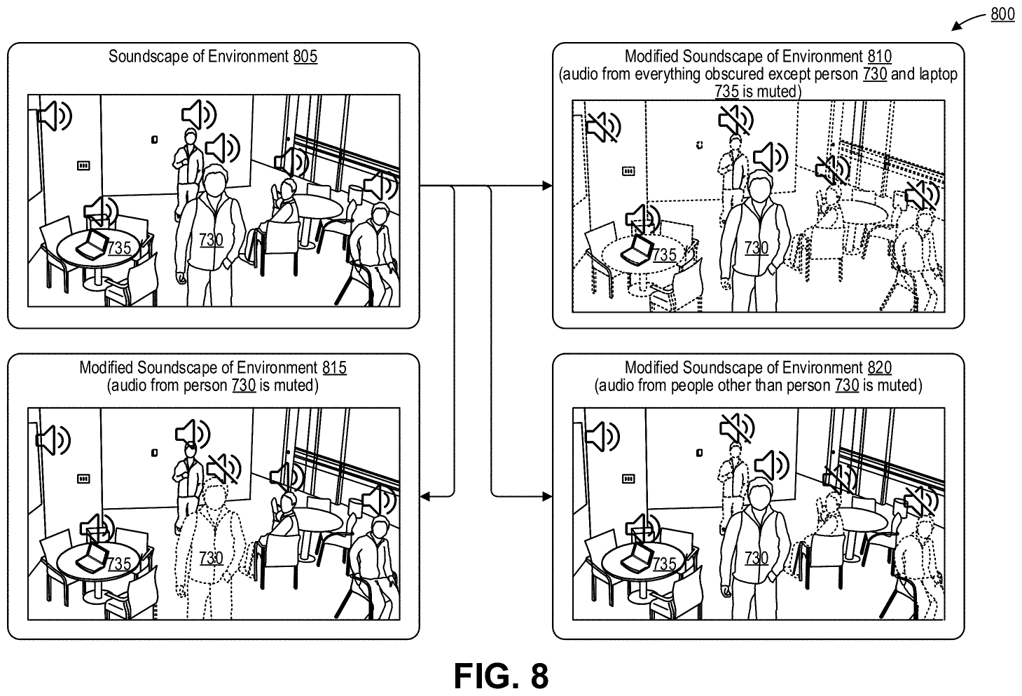

FIG. 8 is a conceptual diagram 800 illustrating examples of a soundscape of an environment 805 and various modifications to attenuate aspects of the soundscape corresponding to different elements in the environment. The soundscape of the environment 805 is illustrated in FIG. 8 as a depiction of the room with four people and the laptop 735 that is also depicted in the image of the environment 705 of FIGS. 7A-7B. The soundscape of the environment 805 is processed by a media processing system, such as the media processing system 200, the media processing system of FIG. 5, and/or the media processing system of FIG. 6. The soundscape of the environment 805 is processed by a media processing system to generate the modified soundscape of the environment 810, the modified soundscape of the environment 815, and/or the modified soundscape of the environment 820.

The soundscape of the environment 805, the modified soundscape of the environment 810, the modified soundscape of the environment 815, and the modified soundscape of the environment 820 include speaker icons above each of the four people in the environment, indicating sound(s) (e.g., voices) from each of the four people. The soundscape of the environment 805, the modified soundscape of the environment 810, the modified soundscape of the environment 815, and the modified soundscape of the environment 820 include speaker icons above the laptop 735, indicating sound(s) from the laptop 735. The soundscape of the environment 805, the modified soundscape of the environment 810, the modified soundscape of the environment 815, and the modified soundscape of the environment 820 include a speaker icon in the upper-left corner, indicating sound(s) from the rest of the environment. Speaker icons that are crossed out represent sounds that are attenuated, silenced, and/or removed by the media modification engine 235. Speaker icons that are not crossed out represent sounds that remain not attenuated, silenced, or removed by the media modification engine 235.

Portions of the modified soundscape of the environment 810, the modified soundscape of the environment 815, and the modified soundscape of the environment 820 whose corresponding sound(s) are attenuated, silenced, and/or removed are illustrated with dashed black lines, and over with. Portions of the modified soundscape of the environment 810, the modified soundscape of the environment 815, and the modified soundscape of the environment 820 whose corresponding sound(s) are not attenuated, silenced, and/or removed are illustrated with solid black lines.

In the modified soundscape of the environment 810, sounds from everything in the environment other than the person 730 and the laptop 735 in the room are attenuated, silenced, and/or removed by the media modification engine 235. In some examples, the person 730 and the laptop 735 appear on an approved list (e.g., a whitelist) and/or everything else in the room appears on a blocked list (e.g., a blacklist).

In the modified soundscape of the environment 815, sounds from the person 730 are attenuated, silenced, and/or removed by the media modification engine 235, while everything else in the room (including the three other people and the laptop) remains not attenuated, silenced, or removed. In some examples, the person 730 appears on the blocked list (e.g., blacklist) and/or everything else in the room appears on an approved list (e.g., a whitelist).

In the modified soundscape of the environment 820, sounds from the three people other than the person 730 are attenuated, silenced, and/or removed by the media modification engine 235, while everything else in the room (including the person 730 and the laptop 735) remains not attenuated, silenced, or removed. In some examples, the person 730 appears on the approved list (e.g., a whitelist) and/or all other people other than the person 730 are on a blocked list (e.g., a blacklist).

In some examples, visual aspects of the media can be obscured as in FIGs.7A or 7B, and audio aspects of the media can be attenuated, silenced, and/or removed as in FIG. 8.

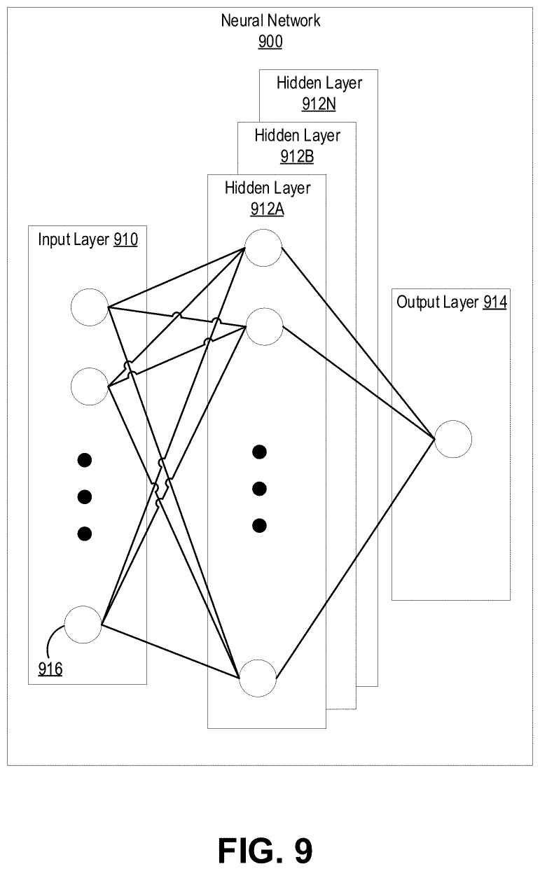

FIG. 9 is a block diagram illustrating an example of a neural network (NN) 900 that can be used for media processing operations. The neural network 900 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 900 may be an example of one of the one or more trained neural networks of the media processing system 200, of the compositor 220, the object detection engine 225, the semantic segmentation engine 230, the media modification engine 235, and/or the gaze tracking engine 270, the foveated compression engine 515, the gaze tracking engine 520, the object detection engine 525, the audio recognition engine 530, the face tracking 615, the semantic segmentation 620, or a combination thereof.

An input layer 910 of the neural network 900 includes input data. The input data of the input layer 910 can include data representing the pixels of one or more input image frames. In some examples, the input data of the input layer 910 includes data representing the pixels of image data (e.g., of images captured by the user-facing sensors 205, the media captured by the environment-facing sensors 210, the virtual content generated by the virtual content generator 215, and/or the combined image generated by the compositor 220), image(s) captured by the third camera 330C, image(s) captured by the fourth camera 330D, image(s) captured by the first camera 430A, image(s) captured by the second camera 430B, the image data 502 of the environment) and/or metadata corresponding to the image data. In some examples, the input data of the input layer 910 includes gaze data from the gaze tracking engine 270, object detection data from the object detection engine 225, semantic segmentation data from the semantic segmentation engine 230, or a combination thereof.

The images can include image data from an image sensor including raw pixel data (including a single color per pixel based, for example, on a Bayer filter) or processed pixel values (e.g., RGB pixels of an RGB image). The neural network 900 includes multiple hidden layers 912A, 912B, through 912N. The hidden layers 912A, 912B, through 912N include “N” number of hidden layers, where “N” is an integer greater than or equal to one. The number of hidden layers can be made to include as many layers as needed for the given application. The neural network 900 further includes an output layer 914 that provides an output resulting from the processing performed by the hidden layers 912A, 912B, through 912N.

In some examples, the output layer 914 can provide an output image, such as the combined image generated by the compositor 220, modified media output by the media modification engine 235, the modified image data 575 of the environment 505, or a combination thereof. In some examples, the output layer 914 can provide gaze data from the gaze tracking engine 270, object detection data from the object detection engine 225, semantic segmentation data from the semantic segmentation engine 230, or a combination thereof.

The neural network 900 is a multi-layer neural network of interconnected filters. Each filter can be trained to learn a feature representative of the input data. Information associated with the filters is shared among the different layers and each layer retains information as information is processed. In some cases, the neural network 900 can include a feed-forward network, in which case there are no feedback connections where outputs of the network are fed back into itself. In some cases, the network 900 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 910 can activate a set of nodes in the first hidden layer 912A. For example, as shown, each of the input nodes of the input layer 910 can be connected to each of the nodes of the first hidden layer 912A. The nodes of a hidden layer can transform the information of each input node by applying activation functions (e.g., filters) to this information. The information derived from the transformation can then be passed to and can activate the nodes of the next hidden layer 912B, which can perform their own designated functions. Example functions include convolutional functions, downscaling, upscaling, data transformation, and/or any other suitable functions. The output of the hidden layer 912B can then activate nodes of the next hidden layer, and so on. The output of the last hidden layer 912N can activate one or more nodes of the output layer 914, which provides a processed output image. In some cases, while nodes (e.g., node 916) in the neural network 900 are shown as having multiple output lines, a node has a single output and all lines shown as being output from a node represent the same output value.

In some cases, each node or interconnection between nodes can have a weight that is a set of parameters derived from the training of the neural network 900. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 910 using the different hidden layers 912A, 912B, through 912N in order to provide the output through the output layer 914.

FIG. 10 is a flow diagram illustrating a process for media processing operations. The process 1000 may be performed by a media processing system. In some examples, the media processing system can include, for example, the image capture and processing system 100, the image capture device 105A, the image processing device 105B, the image processor 150, the ISP 154, the host processor 152, the media processing system 200, the HMD 310, the mobile handset 410, the media processing system of FIG. 5, the media processing system of FIG. 6, the media processing system of FIG. 7A, the media processing system of FIG. 7B, the media processing system of FIG. 8, the neural network 900, the computing system 1100, the processor 1110, or a combination thereof.

At operation 1005, the media processing system is configured to, and can, receive image data captured by an image sensor, the image data representing (e.g., depicting) an environment. In some examples, the media processing system includes an image sensor connector that coupled and/or connects the image sensor to a remainder of the media processing system (e.g., including the processor and/or the memory of the media processing system), In some examples, the media processing system receives the image data from the image sensor by receiving the image data from, over, and/or using the image sensor connector.

Examples of the image sensor includes the image sensor 130, the user-facing sensor(s) 205, the environment-facing sensor(s) 210, the first camera 330A, the second camera 330B, the first camera 430A, the second camera 430B, the third camera 430C, the fourth camera 430D, an image sensor that captures the image data 502, an image sensor that captures the image of the environment 705, an image sensor used to capture an image used as input data for the input layer 910 of the NN 900, the input device 1145, another image sensor described herein, another sensor described herein, or a combination thereof

Examples of the image data include image data captured using the image capture and processing system 100, image data captured using image sensor(s) of the user-facing sensor(s) 205, image data captured using image sensor(s) of the environment-facing sensor(s) 210, image data captured using the first camera 330A, image data captured using the second camera 330B, image data captured using the first camera 430A, image data captured using the second camera 430B, image data captured using the third camera 430C, image data captured using the fourth camera 430D, the image data 502, the image of the environment 705, an image used as input data for the input layer 910 of the NN 900, another image described herein, another set of image data described herein, or a combination thereof

Examples of the environment include the scene 110, the user that the user-facing sensor(s) 205 face, the environment that the environment-facing sensor(s) 210 face, an environment that the HMD 310 is in, an environment that the first camera 330A and/or the second camera 330B capture image data of, an environment that the mobile handset 410 is in, an environment that the first camera 430A and/or the second camera 430B and/or the third camera 430C and/or the fourth camera 430D capture image data of, the environment 505, the environment depicted in the image of the environment 705, the environment represented in the soundscape of the environment 805, another environment or scene described herein, or a combination thereof.

At operation 1010, the media processing system is configured to, and can, receive an indication of an object in the environment that is represented in the image data. In some examples, the object being represented in the image data includes the object being depicted in the image data. Examples of the object include an object detected using the object detection engine 225, an object detected using the object detection engine 525, an object corresponding to the event detection 535, an object that outputs audio detected by the audio recognition engine 530, an object detected using the object detection 550, a hand detected using the hand detection 555, an object that outputs audio detected by the audio detection 560, the person 605, the face tracked in the face tracking 615, the face 625, the body 630, the person 730, the laptop 735, the other people in the image of the environment 705, other objects described herein, or a combination thereof. In some examples, the object can be a person, an animal, a vehicle, a plant, a structure, a device, content displayed on a device, printed content printed on a medium, written content written on a medium, drawn content drawn on a medium, or a combination thereof.

In some aspects, receiving the indication of the object in the environment includes detecting the object in the image data, for instance using the object detection engine 225, the event detection 535, the audio recognition engine 530, the object detection 550, the hand detection 555, the audio detection 560, the face tracking 615, the NN 900, or a combination thereof.

In some aspects, receiving the indication of the object in the environment includes an input through a user interface, the input indicative of the object. In some examples, the input through the user interface can be a touch input through a touchscreen interface, a touch input through a trackpad interface, a click input through a mouse interface, a button input through a button interface, a keyboard input through a keyboard interface, a keypad input through a keypad interface, a gaze input through the user-facing sensor(s) 205 and interpreted using the gaze tracking engine 270, a voice command input through a microphone and/or a speech recognition system, a text command input using a keyboard,

At operation 1015, the media processing system is configured to, and can, divide the image data into a plurality of regions. The plurality of regions includes a first region and a second region. The object is represented in one of the plurality of regions. In some examples, dividing the image data into the plurality of regions is performed by the semantic segmentation engine 230 and/or the semantic segmentation 620. In some examples, the one of the plurality of regions that the object is depicted in is the first region. In some examples, the one of the plurality of regions that the object is depicted in is the second region. Examples of the plurality of regions include the regions of the images in FIGS. 7A, 7B, and 8. For instance, examples of the plurality of regions include regions corresponding to the person 730, the laptop 735, other people in the image of the environment 705, other objects in the in the image of the environment 705, background areas in the in the image of the environment 705, regions of the image of the environment 705, differently-outlined regions of the modified image of the environment 710, differently-outlined regions of the modified image of the environment 715, differently-outlined regions of the modified image of the environment 720, differently-shaded regions of the modified image of the environment 755, differently-shaded regions of the modified image of the environment 760, differently-shaded regions of the modified image of the environment 765, differently-outlined regions of the modified soundscape of the environment 810, differently-outlined regions of the modified soundscape of the environment 815, and differently-outlined regions of the modified soundscape of the environment 820.

In some aspects, dividing the image data into the plurality of regions includes dividing the image data into the plurality of regions based on a determined location of the object. The object is located in at least one region and is not located in at least one other region. In some aspects, the location of the object is determined from the image data, for instance based on object detection. In some aspects, the media processing system is configured to, and can, detect audio, wherein a location of the object is determined based on an attribute of the audio, wherein the attribute includes at least one of a location of the audio, a direction of the audio, an amplitude of the audio, or a frequency of the audio.

In some aspects, at least one region is a region having a predetermined shape, such as a square, a rectangle, a circle, a triangle, a polygon, a portion of any of these shapes, or a combination thereof

At operation 1020, the media processing system is configured to, and can, modify the image data to obscure the first region without obscuring the second region based on the object being represented in the one of the plurality of regions. . Examples of modifying the image data include the media modification engine 235, the modification 565, the image modification 635, the blur 640, the reduced bitrate 645, the increased compression 650, the inpainting 655, the pixelization 660, the modified image data 575, the modified image of the environment 710, the modified image of the environment 715, the modified image of the environment 720, the modified image of the environment 755, the modified image of the environment 760, the modified image of the environment 765, the modified soundscape of the environment 810, the modified soundscape of the environment 815, and the modified soundscape of the environment 820.

In some aspects, the object is represented in the first region and is not represented in the second region, and modifying the image data to obscure the first region is based on the object being represented in the first region and/or being not represented in (e.g., missing from) the second region.

In some aspects, the object is represented in the second region and is not represented in the first region, and modifying the image data to obscure the first region without obscuring the second region is based on the object being represented in the second region and/or being not represented in (e.g., missing from) the first region.

In some aspects, modifying the image data to obscure the first region includes modifying the image data using foveated compression of a peripheral area around a fixation point. In some examples, for instance as in the modified image of the environment 755, the second region includes the fixation point, while the first region includes the peripheral area. In some examples, for instance as in the modified image of the environment 760 and the modified image of the environment 765, the first region includes the fixation point, while the second region includes the peripheral area.

In some aspects, modifying the image data to obscure the first region includes modifying the image data to blur at least a portion of the first region, to remove at least a portion of the first region, to inpaint at least a portion of the first region, to pixelize or pixelate at least a portion of the first region, or a combination thereof.

In some aspects, modifying the image data to obscure the first region includes modifying the image data to reduce a resolution of a first subset of the image data that depicts the first region compared to a second subset of the image data that depicts the second region. In some aspects, modifying the image data to obscure the first region includes modifying the image data to compress a first subset of the image data that depicts the first region more than a second subset of the image data that depicts the second region.

In some aspects, modifying the image data to obscure the first region reduces an amount of data used to code the first region. In some aspects, modifying the image data to obscure the first region comprises at least one of increasing compression in the first region, increasing quantization in the first region, reducing resolution in the first region, cropping the first region, and/or pixelating the first region.

At operation 1025, the media processing system is configured to, and can, output the image data after modifying the image data. In some aspects, outputting the image data includes displaying the image data using output device(s) 240, such as a display. In some aspects, outputting the image data includes sending the image data to a recipient device using a communication transceiver, such as the transceiver(s) 245 and/or the communication interface 1140.

In some aspects, the object includes at least a portion of a body of a person, as in the modified image of the environment 710, the modified image of the environment 715, the modified image of the environment 720, the modified image of the environment 755, the modified image of the environment 760, and the modified image of the environment 765. In some aspects, the object includes at least a portion of a face of a person, as in the modified image of the environment 765. In some aspects, the object includes at least a portion of a string of characters, for instance as in a string displayed on the laptop 735. In some aspects, the object includes at least a portion of content displayed using a display, for instance as in content displayed using the display of the laptop 735.

In some aspects, the media processing system is configured to, and can, receive audio data captured by a microphone from the environment. The audio data is captured at a time corresponding to capture of the image data. The media processing system detects, within the audio data, an audio sample corresponding to the object. The media processing system modifies the audio data to attenuate the audio sample corresponding to the object, and outputs the audio data after modifying the audio data. Examples of such modification of audio data include the modified soundscape of the environment 810, the modified soundscape of the environment 815, and the modified soundscape of the environment 820. In some aspects, outputting the audio data includes playing the image data using output device(s) 240, such as speakers and/or headphones. In some aspects, outputting the audio data includes sending the audio data to a recipient device using a communication transceiver, such as the transceiver(s) 245 and/or the communication interface 1140.

In some aspects, the media processing system is configured to, and can, receive secondary image data from a second image sensor. Examples of the secondary image data include any of the examples listed above for the image data. Examples of the second image sensor include any of the examples listed above for the image sensor as well as the third camera 330C and/or the fourth camera 330D. The second image sensor has a different field of view to the image sensor. The secondary image data captured by the second image sensor includes a secondary image of a user. The dividing of the image data at operation 1015 is further based on the secondary image. In some aspects, the second image sensor captures a gesture or position of at least a portion of the user, and the dividing of the image data includes defining a region corresponding to a direction of the gesture and/or position of at least the portion of the user. In some aspects, the gesture or position of the user comprises a gaze direction of the user, for instance as determined by the gaze tracking engine 270 where the secondary image sensor is one of the user-facing sensor(s) 205 (e.g., the third camera 330C, the fourth camera 330D, the first camera 430A, the second camera 430B).

In some aspects, the media processing system is configured to, and can, identify the object. The media processing system can determine whether the object is to be displayed or obscured based on identifying the object. In some examples media processing system can define the first region to include the object in response to determining whether the object is to be obscured or displayed. In some aspects, determining that the object is to be obscured comprises determining that the object is included in a black list of objects to be obscured and/or determining that the object is not included in a white list of objects to be displayed. In some aspects, determining that the object is to be displayed comprises determining that the object is included in a white list of objects to be displayed and/or determining that the object is not included in a black list of objects to be obscured.

In some examples, the media processing system can includes: means for receiving image data captured by an image sensor, the image data depicting an environment; means for receiving an indication of an object in the environment that is represented in the image data; means for dividing the image data into a plurality of regions, wherein the plurality of regions includes a first region and a second region, wherein the object is represented in one of the plurality of regions; means for modifying the image data to obscure the first region without obscuring the second region based on the object being represented in the one of the plurality of regions; and means for outputting the image data after modifying the image data.

In some examples, the means for receiving the image data includes the image capture and processing system 100, the image capture device 105A, the image processing device 105B, the image processor 150, the ISP 154, the host processor 152, the image sensor 130, the user-facing sensor(s) 205, the environment-facing sensor(s) 210, the first camera 330A, the second camera 330B, the first camera 430A, the second camera 430B, the third camera 430C, the fourth camera 430D, an image sensor that captures the image data 502, an image sensor that captures the image of the environment 705, an image sensor used to capture an image used as input data for the input layer 910 of the NN 900, the input device 1145, another image sensor described herein, another sensor described herein, or a combination thereof.

In some examples, the means for receiving the indication of the object in the environment includes the image processor 150, the ISP 154, the host processor 152, the object detection engine 225, the object detection engine 525, the event detection 535, the audio recognition engine 530, the object detection 550, the hand detection 555, the audio detection 560, the face tracking 615, the NN 900, the computing system 1100, the processor 1110, or a combination thereof

In some examples, the means for dividing the image data into the plurality of regions includes the image processor 150, the ISP 154, the host processor 152, the semantic segmentation engine 230, the semantic segmentation 620, the NN 900, the computing system 1100, the processor 1110, or a combination thereof.

In some examples, the means for modifying the image data includes the image processor 150, the ISP 154, the host processor 152, the media modification engine 235, the modification 565, the image modification 635, the blur 640, the reduced bitrate 645, the increased compression 650, the inpainting 655, the pixelization 660, the NN 900, the computing system 1100, the processor 1110, or a combination thereof.

In some examples, the means for outputting the image data includes the image processor 150, the ISP 154, the host processor 152, the output device(s) 240, the transceiver(s) 245, the computing system 1100, the output device 1135, the communication interface 1140, or a combination thereof

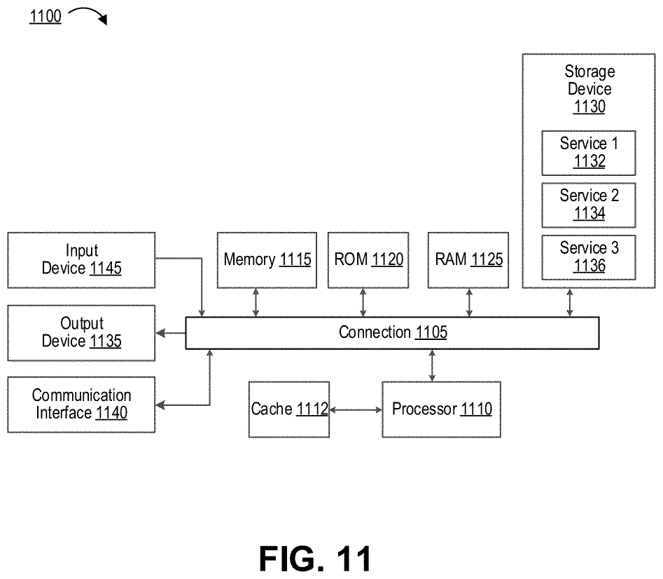

In some examples, the processes described herein (e.g., the process 500, the process 600, and the process 1000, as well as the processes of FIGS. 1, 2, 7A, 7B, 8, 9 and/or 11, and/or other processes described herein) may be performed by a computing device or apparatus. In some examples, the processes described herein can be performed by the processing system 100, the image capture device 105A, the image processing device 105B, the image processor 150, the ISP 154, the host processor 152, the media processing system 200, the HMD 310, the mobile handset 410, the media processing system of FIG. 5, the media processing system of FIG. 6, the media processing system of FIG. 7A, the media processing system of FIG. 7B, the media processing system of FIG. 8, the neural network 900, the media processing system of FIG. 11, the computing system 1100, the processor 1110, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc.

Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards.

Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“”) and greater than or equal to (“”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: An apparatus for media processing, the apparatus comprising: a memory; and one or more processors coupled to the memory, the one or more processors configured to: receive image data captured by an image sensor, the image data depicting an environment;

receive an indication of an object in the environment that is represented in the image data; divide the image data into a plurality of regions, wherein the plurality of regions includes a first region and a second region, wherein the object is represented in one of the plurality of regions; modify the image data to obscure the first region without obscuring the second region based on the object being represented in the one of the plurality of regions; and output the image data after modifying the image data.

Aspect 2. The apparatus of Aspect 1, wherein, to divide the image data into the plurality of regions, the one or more processors are configured to divide the image data into the plurality of regions based on a determined location of the object, wherein the object is located in at least one region and is not located in at least one other region.

Aspect 3. The apparatus of any of Aspects 1 to 2, wherein a location of the object is determined from the image data.

Aspect 4. The apparatus of any of Aspects 1 to 3, the one or more processors are configured to: detect audio, wherein a location of the object is determined based on an attribute of the audio, wherein the attribute includes at least one of a location of the audio, a direction of the audio, an amplitude of the audio, or a frequency of the audio.

Aspect 5. The apparatus of any of Aspects 1 to 4, wherein, to receive the indication of the object in the environment, the one or more processors are configured to detect the object in the image data.

Aspect 6. The apparatus of any of Aspects 1 to 5, wherein, to receive the indication of the object in the environment, the one or more processors are configured to receive an input through a user interface, the input indicative of the object.

Aspect 7. The apparatus of any of Aspects 1 to 6, wherein the object is represented in the first region and is not represented in the second region, wherein modifying the image data to obscure the first region is based on the object being depicted in the first region.

Aspect 8. The apparatus of any of Aspects 1 to 7, wherein the object is represented in the second region and is not represented in the first region, wherein modifying the image data to obscure the first region without obscuring the second region is based on the object being depicted in the second region and being not represented in the first region.

Aspect 9. The apparatus of any of Aspects 1 to 8, wherein modifying the image data to obscure the first region includes modifying the image data using foveated compression of a peripheral area around a fixation point, wherein the second region includes the fixation point, wherein the first region includes the peripheral area.

Aspect 10. The apparatus of any of Aspects 1 to 9, wherein modifying the image data to obscure the first region includes modifying the image data to blur at least a portion of the first region.

Aspect 11. The apparatus of any of Aspects 1 to 10, wherein modifying the image data to obscure the first region includes modifying the image data to remove at least a portion of the first region.

Aspect 12. The apparatus of any of Aspects 1 to 11, wherein modifying the image data to obscure the first region includes modifying the image data to inpaint at least a portion of the first region.

Aspect 13. The apparatus of any of Aspects 1 to 12, wherein modifying the image data to obscure the first region includes modifying the image data to pixelize at least a portion of the first region.

Aspect 14. The apparatus of any of Aspects 1 to 13, wherein modifying the image data to obscure the first region includes modifying the image data to reduce a resolution of a first subset of the image data that depicts the first region compared to a second subset of the image data that depicts the second region.

Aspect 15. The apparatus of any of Aspects 1 to 14, wherein modifying the image data to obscure the first region includes modifying the image data to compress a first subset of the image data that depicts the first region more than a second subset of the image data that depicts the second region.

Aspect 16. The apparatus of any of Aspects 1 to 15, wherein the object includes at least a portion of a body of a person.

Aspect 17. The apparatus of any of Aspects 1 to 16, wherein the object includes at least a portion of a face of a person.

Aspect 18. The apparatus of any of Aspects 1 to 17, wherein the object includes at least a portion of a string of characters.

Aspect 19. The apparatus of any of Aspects 1 to 18, wherein the object includes at least a portion of content displayed using a display.

Aspect 20. The apparatus of any of Aspects 1 to 19, further comprising: a display, wherein, to output the image data, the one or more processors are configured to display the image data using the display.

Aspect 21. The apparatus of any of Aspects 1 to 20, further comprising: a communication transceiver, wherein, to output the image data, the one or more processors are configured to send the image data to a recipient device using the communication transceiver.

Aspect 22. The apparatus of any of Aspects 1 to 21, wherein the one or more processors are configured to: receive audio data captured by a microphone from the environment, the audio data captured at a time corresponding to capture of the image data; detect, within the audio data, an audio sample corresponding to the object; modify the audio data to attenuate the audio sample corresponding to the object; and output the audio data after modifying the audio data.

Aspect 23. The apparatus of any of Aspects 1 to 22, wherein at least one region is a region having a predetermined shape.

Aspect 24. The apparatus of any of Aspects 1 to 23, wherein the one or more processors are configured to receive secondary image data from a second image sensor, the second image sensor having a different field of view to the first image sensor, the secondary image data captured by the second image sensor including a secondary image of a user, wherein the dividing of the image data is further based on the secondary image.

Aspect 25. The apparatus of Aspect 24, wherein the second image sensor captures a gesture or position of at least a portion of the user, and wherein the dividing of the image data includes defining a region corresponding to a direction of the gesture and/or position of at least the portion of the user.

Aspect 26. The apparatus of Aspect 25, wherein the gesture or position of the user comprises a gaze direction of the user.

Aspect 27. The apparatus of any of Aspects 1 to 26, wherein modifying the image data to obscure the first region reduces an amount of data used to code the first region.

Aspect 28. The apparatus of Aspect 27, wherein modify the image data to obscure the first region comprises at least one of increasing compression in the first region, increasing quantization in the first region, reducing resolution in the first region, cropping the first region, and/or pixelating the first region.

Aspect 29. The apparatus of any of Aspects 1 to 28, further comprising identifying the object, determining whether the object detected is to be displayed or obscured, and defining the first region to include the object when it is determined that the object is to be obscured.

Aspect 30. The apparatus of Aspect 29, wherein determining that the object is to be obscured comprises determining that the object is included in a black list of objects to be obscured and/or determining that the object is not included in a white list of objects to be displayed.

Aspect 31. A method for media processing, the method comprising: receiving image data captured by an image sensor, the image data depicting an environment; receiving an indication of an object in the environment that is represented in the image data; dividing the image data into a plurality of regions, wherein the plurality of regions includes a first region and a second region, wherein the object is represented in one of the plurality of regions; modifying the image data to obscure the first region without obscuring the second region based on the object being represented in the one of the plurality of regions; and outputting the image data after modifying the image data.

Aspect 32. The method of Aspect 31, wherein dividing the image data into the plurality of regions includes dividing the image data into the plurality of regions based on a determined location of the object, wherein the object is located in at least one region and is not located in at least one other region.

Aspect 33. The method of any of Aspects 31 to 32, wherein a location of the object is determined from the image data.

Aspect 34. The method of any of Aspects 31 to 33, further comprising: detecting audio, wherein a location of the object is determined based on an attribute of the audio, wherein the attribute includes at least one of a location of the audio, a direction of the audio, an amplitude of the audio, or a frequency of the audio.

Aspect 35. The method of any of Aspects 31 to 34, wherein receiving the indication of the object in the environment includes detecting the object in the image data.

Aspect 36. The method of any of Aspects 31 to 35, wherein receiving the indication of the object in the environment includes an input through a user interface, the input indicative of the object.

Aspect 37. The method of any of Aspects 31 to 36, wherein the object is represented in the first region and is not represented in the second region, wherein modifying the image data to obscure the first region is based on the object being depicted in the first region.

Aspect 38. The method of any of Aspects 31 to 37, wherein the object is represented in the second region and is not represented in the first region, wherein modifying the image data to obscure the first region without obscuring the second region is based on the object being depicted in the second region and being not represented in the first region.

Aspect 39. The method of any of Aspects 31 to 38, wherein modifying the image data to obscure the first region includes modifying the image data using foveated compression of a peripheral area around a fixation point, wherein the second region includes the fixation point, wherein the first region includes the peripheral area.

Aspect 40. The method of any of Aspects 31 to 39, wherein modifying the image data to obscure the first region includes modifying the image data to blur at least a portion of the first region.

Aspect 41. The method of any of Aspects 31 to 40, wherein modifying the image data to obscure the first region includes modifying the image data to remove at least a portion of the first region.

Aspect 42. The method of any of Aspects 31 to 41, wherein modifying the image data to obscure the first region includes modifying the image data to inpaint at least a portion of the first region.

Aspect 43. The method of any of Aspects 31 to 42, wherein modifying the image data to obscure the first region includes modifying the image data to pixelize at least a portion of the first region.

Aspect 44. The method of any of Aspects 31 to 43, wherein modifying the image data to obscure the first region includes modifying the image data to reduce a resolution of a first subset of the image data that depicts the first region compared to a second subset of the image data that depicts the second region.

Aspect 45. The method of any of Aspects 31 to 44, wherein modifying the image data to obscure the first region includes modifying the image data to compress a first subset of the image data that depicts the first region more than a second subset of the image data that depicts the second region.

Aspect 46. The method of any of Aspects 31 to 45, wherein the object includes at least a portion of a body of a person.

Aspect 47. The method of any of Aspects 31 to 46, wherein the object includes at least a portion of a face of a person.

Aspect 48. The method of any of Aspects 31 to 47, wherein the object includes at least a portion of a string of characters.

Aspect 49. The method of any of Aspects 31 to 48, wherein the object includes at least a portion of content displayed using a display.

Aspect 50. The method of any of Aspects 31 to 49, wherein outputting the image data includes displaying the image data using a display.

Aspect 51. The method of any of Aspects 31 to 50, wherein outputting the image data includes sending the image data to a recipient device using a communication transceiver.

Aspect 52. The method of any of Aspects 31 to 51, further comprising: receiving audio data captured by a microphone from the environment, the audio data captured at a time corresponding to capture of the image data; detecting, within the audio data, an audio sample corresponding to the object; modifying the audio data to attenuate the audio sample corresponding to the object; and outputting the audio data after modifying the audio data.

Aspect 53. The method of any of Aspects 31 to 52, wherein at least one region is a region having a predetermined shape.

Aspect 54. The method of any of Aspects 31 to 53, further comprising: receiving secondary image data from a second image sensor, the second image sensor having a different field of view to the first image sensor, the secondary image data captured by the second image sensor including a secondary image of a user, wherein the dividing of the image data is further based on the secondary image.

Aspect 55. The method of Aspect 54, wherein the second image sensor captures a gesture or position of at least a portion of the user, and wherein the dividing of the image data includes defining a region corresponding to a direction of the gesture and/or position of at least the portion of the user.

Aspect 56. The method of any of Aspects 31 to 55, wherein the gesture or position of the user comprises a gaze direction of the user.

Aspect 57. The method of any of Aspects 31 to 56, wherein modifying the image data to obscure the first region reduces an amount of data used to code the first region.

Aspect 58. The method of Aspect 57, wherein modify the image data to obscure the first region comprises at least one of increasing compression in the first region, increasing quantization in the first region, reducing resolution in the first region, cropping the first region, and/or pixelating the first region.

Aspect 59. The method of any of Aspects 31 to 58, further comprising: identifying the object; and determining whether the object is to be displayed or obscured based on identifying the object; and defining the first region to include the object in response to determining that the object is to be obscured.

Aspect 60. The method of Aspect 59, wherein determining that the object is to be obscured comprises determining that the object is included in a black list of objects to be obscured and/or determining that the object is not included in a white list of objects to be displayed.

Aspect 61: A non-transitory computer-readable medium having stored thereon instructions that, when executed by one or more processors, cause the one or more processors to: receive image data captured by an image sensor, the image data depicting an environment; receive an indication of an object in the environment that is represented in the image data; divide the image data into a plurality of regions, wherein the plurality of regions includes a first region and a second region, wherein the object is represented in one of the plurality of regions; modify the image data to obscure the first region without obscuring the second region based on the object being represented in the one of the plurality of regions; and output the image data after modifying the image data.

Aspect 62: The non-transitory computer-readable medium of Aspect 61, further comprising operations according to any of Aspects 2 to 30, and/or any of Aspects 32 to 60.

Aspect 63: An apparatus for image processing, the apparatus comprising: means for receiving image data captured by an image sensor, the image data depicting an environment; means for receiving an indication of an object in the environment that is represented in the image data; means for dividing the image data into a plurality of regions, wherein the plurality of regions includes a first region and a second region, wherein the object is represented in one of the plurality of regions; means for modifying the image data to obscure the first region without obscuring the second region based on the object being represented in the one of the plurality of regions; and means for outputting the image data after modifying the image data.

Aspect 64: The apparatus of Aspect 63, further comprising means for performing operations according to any of Aspects 2 to 30, and/or any of Aspects 32 to 60.

What is claimed is:

1. An apparatus for media processing, the apparatus comprising:
at least one memory; and
one or more processors coupled to the at least one memory, the one or more processors configured to:
receive image data captured by an image sensor, the image data representing an environment;
receive an indication of an object in the environment that is represented in the image data;
divide the image data into a plurality of regions, wherein the plurality of regions includes a first region and a second region, wherein the object is represented in one of the plurality of regions;
modify the image data to obscure the first region without obscuring the second region based on the object being represented in the one of the plurality of regions; and
output the image data after modifying the image data.

2. The apparatus of claim 1, wherein, to divide the image data into the plurality of regions, the one or more processors are configured to divide the image data into the plurality of regions based on a determined location of the object, wherein the object is located in at least one region and is not located in at least one other region.

3. The apparatus of claim 1, wherein a location of the object is determined from the image data.

4. The apparatus of claim 1, the one or more processors are configured to:
detect audio, wherein a location of the object is determined based on an attribute of the audio, wherein the attribute includes at least one of a location of the audio, a direction of the audio, an amplitude of the audio, or a frequency of the audio.

5. The apparatus of claim 1, wherein, to receive the indication of the object in the environment, the one or more processors are configured to detect the object in the image data.

6. The apparatus of claim 1, wherein, to receive the indication of the object in the environment, the one or more processors are configured to receive an input through a user interface, the input indicative of the object.

7. The apparatus of claim 1, wherein the object is represented in the first region and is not represented in the second region, wherein modifying the image data to obscure the first region is based on the object being represented in the first region.

8. The apparatus of claim 1, wherein the object is represented in the second region and is not represented in the first region, wherein modifying the image data to obscure the first region without obscuring the second region is based on the object being represented in the second region and being not represented in the first region.

9. The apparatus of claim 1, wherein modifying the image data to obscure the first region includes modifying the image data using foveated compression of a peripheral area around a fixation point, wherein the second region includes the fixation point, wherein the first region includes the peripheral area.

10. The apparatus of claim 1, wherein modifying the image data to obscure the first region includes modifying the image data to blur at least a portion of the first region.

11. The apparatus of claim 1, wherein modifying the image data to obscure the first region includes modifying the image data to remove at least a portion of the first region.

12. The apparatus of claim 1, wherein modifying the image data to obscure the first region includes modifying the image data to inpaint at least a portion of the first region.

13. The apparatus of claim 1, wherein modifying the image data to obscure the first region includes modifying the image data to pixelize at least a portion of the first region.

14. The apparatus of claim 1, wherein modifying the image data to obscure the first region includes modifying the image data to reduce a resolution of a first subset of the image data that represents the first region compared to a second subset of the image data that represents the second region.

15. The apparatus of claim 1, wherein modifying the image data to obscure the first region includes modifying the image data to compress a first subset of the image data that represents the first region more than a second subset of the image data that represents the second region.

16. The apparatus of claim 1, wherein the object includes at least a portion of a body of a person.

17. The apparatus of claim 1, wherein the object includes at least a portion of a face of a person.

18. The apparatus of claim 1, wherein the object includes at least a portion of a string of characters.

19. The apparatus of claim 1, wherein the object includes at least a portion of content displayed using a display.

20. The apparatus of claim 1, further comprising:
a display, wherein, to output the image data, the one or more processors are configured to display the image data using the display.

21. The apparatus of claim 1, further comprising:
a communication transceiver, wherein, to output the image data, the one or more processors are configured to send the image data to a recipient device using the communication transceiver.

22. The apparatus of claim 1, wherein the one or more processors are configured to:
receive audio data captured by a microphone from the environment, the audio data captured at a time corresponding to capture of the image data;
detect, within the audio data, an audio sample corresponding to the object;
modify the audio data to attenuate the audio sample corresponding to the object; and
output the audio data after modifying the audio data.

23. A method for media processing, the method comprising:
receiving image data captured by an image sensor, the image data representing an environment;
receiving an indication of an object in the environment that is represented in the image data;
dividing the image data into a plurality of regions, wherein the plurality of regions includes a first region and a second region, wherein the object is represented in one of the plurality of regions;
modifying the image data to obscure the first region without obscuring the second region based on the object being represented in the one of the plurality of regions; and
outputting the image data after modifying the image data.

24. The method of claim 23, wherein dividing the image data into the plurality of regions includes dividing the image data into the plurality of regions based on a determined location of the object, wherein the object is located in at least one region and is not located in at least one other region.

25. The method of claim 23, wherein receiving the indication of the object in the environment includes detecting the object in the image data.

26. The method of claim 23, wherein receiving the indication of the object in the environment includes an input through a user interface, the input indicative of the object.

27. The method of claim 23, wherein modifying the image data to obscure the first region includes modifying the image data to compress, blur, remove, inpaint, or pixelize at least a portion of the first region.

28. The method of claim 23, wherein modifying the image data to obscure the first region includes modifying the image data to reduce a resolution of a first subset of the image data that represents the first region compared to a second subset of the image data that represents the second region.

29. The method of claim 23, wherein modifying the image data to obscure the first region includes modifying the image data to compress a first subset of the image data that represents the first region more than a second subset of the image data that represents the second region.

30. The method of claim 23, further comprising:
receiving audio data captured by a microphone from the environment, the audio data captured at a time corresponding to capture of the image data;
detecting, within the audio data, an audio sample corresponding to the object;
modifying the audio data to attenuate the audio sample corresponding to the object; and
outputting the audio data after modifying the audio data.
